(19) United States
(12) Patent Application Publication
(10) Pub. No.: US 2026/0266690 A1
(43) Pub. Date: Sep. 10, 2026

(54) SYSTEMS, METHODS, AND MEDIA FOR MONITORING A STATE OF AT LEAST ONE ROTATING COMPONENT OF A VEHICLE BASED ON VIBRATION OF A COMPONENT COUPLED THERETO

(71) Applicant: Fontaine Fifth Wheel Company, Jasper, AL (US)

(72) Inventor: Will Brandon Drake, Cullman, AL (US)

(73) Assignee: Fontaine Fifth Wheel Company, Jasper, AL (US)

(21) Appl. No.: 19/553,736

(22) Filed: Mar. 2, 2026

Related U.S. Application Data
(60) Provisional application No. 63/767,127, filed on Mar. 5, 2025.

(51) Int. Cl. G01M 13/045; G01H 11/08

(52) U.S. Cl. CPC G01M 13/045; G01H 11/08

(57) ABSTRACT

In accordance with some embodiments, systems, methods and media for monitoring a state of at least one rotating component of a vehicle based on vibration of a component coupled thereto are provided. In some embodiments, the system comprises: a vibration sensor configured to be mounted to a first vehicle component which is coupled to a second vehicle component; and a processor configured to: provide a frequency domain representation of a sample of vibration data recorded using the vibration sensor to a trained machine learning model to predict a state of the second vehicle component based on vibrations of the first vehicle component; receive, from the trained model, an output indicative of a predicted state of the second vehicle component; and transmit a signal to an external device that is indicative of a current predicted state of the second vehicle component.

### CROSS-REFERENCE TO RELATED APPLICATIONS

This application claims priority to U.S. Provisional Patent Application No. 63/767,127, filed Mar. 5, 2025, the contents of which is hereby incorporated by reference in its entirety.

### BACKGROUND

Tire pressure monitoring systems (TPMS) have become commonplace as original equipment in most newer passenger vehicles, and are also available as after-market equipment for use with large commercial vehicles (e.g., tractors and trailers of class 8 vehicles) and large passenger vehicles (e.g., recreational vehicles). There are also wheel end monitoring (WEM) systems available that are intended to detect wear or damage to wheel components, such as to detect worn bearings, or thermal events that may cause tire blowouts or fires. In general, each of these systems uses sensors mounted to the tire or wheel, and rotate with the tire. Many such systems generally use battery-powered wireless communication if configured to provide information to an operator of the vehicle during operation, while some others have an interface that can only be read while the vehicle is not being operated (e.g., WEMs that utilize a read key that activates an LED that indicates a monitored condition) or are in a particular location (e.g., systems with sensors that can be read by a monitoring system installed at a truck yard). Automatic tire inflation systems (ATIS) are also available for large commercial vehicle trailers that are configured to maintain tire pressure. Such systems are often configured to deliver compressed air to the tires through devices installed within the axle and spindle. Mechanical indicators are available that can be mounted to lug nuts to provide a visual indicator that can be visually inspected to determine whether the orientation of a lug nut has changed.

### SUMMARY

In accordance with some embodiments of the disclosed subject matter, a system for monitoring a state of a rotating vehicle component is provided, the system comprising: a vibration sensor configured to be mounted to a first vehicle component which is coupled to a second vehicle component; and one or more hardware processors configured to: provide a frequency domain representation of a sample of vibration data recorded using the vibration sensor to a trained machine learning model that is trained to predict a state of the second vehicle component based on vibrations of the first vehicle component; receive, from the trained machine learning model, an output indicative of a predicted state of the second vehicle component at a time that the sample of vibration data was recorded; and transmit a signal to an external device that is indicative of a current predicted state of the second vehicle component.

In some embodiments, the one or more hardware processors are further configured to: receive, from a vibration data source, the sample of vibration data; normalize the sample of vibration data; and convert the sample of vibration data to the frequency domain representation.

In some embodiments, the vibration data source comprises the vibration sensor.

In some embodiments, the frequency domain representation comprises a spectrogram.

In some embodiments, the vibration sensor comprises a piezoelectric microphone.

In some embodiments, the trained machine learning model is a classification model that is trained to predict a likelihood that the second vehicle component coupled to the first vehicle component from which the vibration data was recorded is an example of each of a plurality of classes.

In some embodiments, the first vehicle component and the second vehicle component are rotatably coupled portions of an axle assembly of a vehicle, and wherein the trained machine learning model is trained to predict whether the first vehicle component and second vehicle component are securely coupled.

In some embodiments, the first vehicle component is a non-rotating portion of a beam axle of the axle assembly, the second vehicle component is a rotating portion of a hub assembly of the axle assembly, and the plurality of classes includes a properly torqued spindle nut class indicative of whether a spindle nut used to secure the hub assembly to the non-rotating portion of the beam axle is properly torqued, indicating that the first vehicle component and second vehicle component are securely coupled.

In some embodiments, the one or more hardware processors are further configured to: receive, from the trained machine learning model, a plurality of outputs indicative of a predicted state of the second vehicle component at different times; and determine a final prediction based on the plurality of outputs; determine that a user is to be presented with an alert based on the final prediction; and transmit the signal to the external device, thereby causing an alert to be presented to the user by the external device.

In some embodiments, the external device is a mobile computing device associated with the user.

In some embodiments, the first vehicle component and the second vehicle component are portions of an axle assembly of a trailer that is configured to be coupled to a tractor via a fifth wheel.

In some embodiments, the external device is an embedded computing device of the tractor.

In some embodiments, the external device is a dashboard of the tractor.

In some embodiments, the external device is a telematics system of the trailer.

In some embodiments, the external device is a remote computing device associated with a cloud computing service.

In some embodiments, the one or more hardware processors are further configured to: receive, from the vibration sensor, a stream of audio data; record a portion of the stream of audio data as an audio file; divide the audio file into a plurality of vibration data samples, including the sample of vibration data; normalize each of the plurality of the vibration data samples based on audio levels within the respective sample; convert the plurality of vibration data samples into a plurality of mel spectrograms; provide the plurality of mel spectrograms to the trained machine learning model as a batch; receive a plurality of outputs, each corresponding to a respective vibration data sample of the plurality of vibration data samples, and each indicative of the predicted state of the second vehicle component at the time that the respective vibration data sample was recorded; and determine a final prediction based on the plurality of outputs.

In some embodiments, the audio file corresponds to about 16 seconds of audio data recorded at a sample rate of 96 kHz, and wherein each of the vibration data samples corresponds to about two seconds of the audio file, and is downsampled to a sample rate of 10 kHz.

In some embodiments, the trained machine learning model is a regression model that is trained to predict a current state of the second vehicle component coupled to the first vehicle component from which the vibration data was recorded from a range of states.

In some embodiments, the second vehicle component comprises one of the following vehicle components: a lug nut; a set of lug nuts; a lug bolt; a set of lug bolts; a spindle nut; a set of spindle nuts; a bearing of a hub assembly; a set of bearings of a hub assembly; a brake pad; a brake drum; a brake rotor; a brake caliper; a tire; or a set of tires.

In some embodiments, the predicted state is one of the following: whether the lug nut is not properly torqued; whether at least one lug nut of the set of lug nuts is not properly torqued; whether the lug bolt is not properly torqued; whether at least one lug bolt of the set of lug bolts is not properly torqued; whether the spindle nut is not properly torqued; whether at least one spindle nut of the set of spindle nuts is not properly torqued; whether the bearing is not properly lubricated; whether the bearing is worn; whether the set of bearings is not properly lubricated; whether the set of bearings is worn; whether the brake pad is worn; whether the brake pad is damaged; whether the brake drum is worn; whether the brake drum is damaged; whether the brake rotor is worn; whether the brake rotor is damaged; whether the brake caliper is worn; whether the brake caliper is damaged; whether the tire is not properly inflated; whether the tire is damaged; whether at least one tire of the set of tires is not properly inflated; or whether at least one tire of the set of tires is damaged.

In some embodiments, the predicted state is an approximate load on the second vehicle component.

In some embodiments, the one or more hardware processors are further configured to: provide a second frequency domain representation of the sample of vibration data to a second trained machine learning model that is trained to predict a state of a third vehicle component based on vibrations of the first vehicle component.

In some embodiments, each of the second vehicle component and the third vehicle component comprises a different one of the following vehicle components: a lug nut; a set of lug nuts; a lug bolt; a set of lug bolts; a spindle nut; a set of spindle nuts; a bearing of a hub assembly; a set of bearings of a hub assembly; a brake pad; a brake drum; a brake rotor; a brake caliper; a tire; or a set of tires.

In some embodiments, the system further comprises: the first vehicle component, wherein the vibration sensor is mounted to the first vehicle component; and the second vehicle component, wherein the second vehicle component is coupled to the first vehicle component, such that vibrations of the second vehicle component are transmitted to the vibration sensor via the first vehicle component.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a top view of an axle assembly of a vehicle and a system for monitoring a state of at least one rotating component of the vehicle based on vibration of another component of the vehicle in accordance with some embodiments of the disclosed subject matter.

FIG. 2 shows an example of a system for monitoring a state of at least one rotating component of the vehicle in accordance with some embodiments of the disclosed subject matter.

FIG. 3 shows an example of hardware that can be used to implement a vibration data source, a local computing device, and a remote computing device in accordance with some embodiments of the disclosure.

FIG. 4 shows an example of a flow for training and using mechanisms for monitoring a rotating component of a vehicle based on vibration of a component coupled thereto in accordance with some embodiments of the disclosed subject matter.

FIG. 5 shows an example of a process for monitoring a rotating component of a vehicle based on vibration of a component coupled in accordance with some embodiments of the disclosed subject matter.

FIG. 6 shows an example of a process for pre-processing vibration data in accordance with some embodiments of the disclosed subject matter.

FIG. 7A shows an example of a high level architecture of a machine learning model that can be used to implement mechanisms for monitoring a rotating component of a vehicle based on vibration of a component coupled in accordance with some embodiments of the disclosed subject matter.

FIG. 7B shows an example of a spectrogram that can be used to train a machine learning model in accordance with some embodiments of the disclosed subject matter.

### DETAILED DESCRIPTION

In general, available tire and/or wheel monitoring systems use sensors that are attached to, and/or embedded within, a tire, wheel, or wheel hub, and are therefore required to rotate with the wheel and/or tire. Such systems generally require power to maintain sensor functionality over extended periods of vehicle operation, which can be provided from batteries within the sensors and/or recently proposed complex on-board power generators that rotate with the sensors. Some types of monitoring systems (e.g., TPMS) use relatively little power, and can operate for an extended period of time before the battery must be replaced (which may require replacement of the entire sensor if the battery is not replaceable). Other types of systems can require more frequent battery replacement, for example due to characteristics of the sensors, complexity of the measurements, and/or the frequency with which measurements are taken.

Additionally, such monitoring systems often rely on wireless communications to communicate sensor readings to an end user, often via a dedicated user interface device that is intended to be mounted within the cab. When such systems are used to monitor multiple sensors, each wireless sensor generally requires a commissioning sequence to be carried out by a user (e.g., a vehicle operator for some consumer facing systems, the assembler at the factory for some OEM systems, and/or by a technician that is installing an aftermarket system or replacing a sensor after the initial point of sale). During such a commissioning sequence, an operator assigns the sensor to a physical location on the vehicle and may provide other configurations to the system. This can be time consuming, may lead to errors, and may also require range extenders for systems that are mounted relatively far from the user interface device or other wireless receiver of the system.

In some embodiments, mechanisms described herein can use sensors that are mounted to non-rotating components of the vehicle, such as a trailer axle, to monitor a condition of one or more other components of the vehicle, which may or may not rotate with a wheel of the vehicle. In some embodiments, mechanisms described herein can facilitate monitoring of rotating and non-rotating vehicle components using a sensor that is mounted to a non-rotating vehicle component that is mechanically coupled to the vehicle component(s) to be monitored, and collect vibration data from the non-rotating component that includes vibrations caused during operation of the component(s) to be monitored.

In some embodiments, a sensor mounted to a non-rotating vehicle component that is used to monitor rotating and non-rotating vehicle components coupled to the component to which the sensor is mounted can be coupled to power and/or a computing device using a wired connection(s), which can facilitate monitoring for as long as power is provided and other components (e.g., the sensor, the computing device, etc.) are in good repair, which can reduce or eliminate the need to change batteries, replace sensors, and/or utilize costly and unproven power generation devices.

In some embodiments, vehicle component monitoring sensors that are connected using a wired connection(s) can mitigate or eliminate the need to perform a commissioning sequence to associate particular wireless sensors to particular locations, which can reduce the time and complexity of an installation and/or activation process. For example, if a particular wire and/or connector is associated with a particular location on a vehicle, connecting the sensor via that wire and/or connector can automatically associate the sensor with the particular location.

In some embodiments, mechanisms described herein can facilitate monitoring of multiple vehicle components using a single type of sensor. For example, as described below, mechanisms described herein can facilitate monitoring of various aspects of wheel hub health (e.g., end play between the wheel hub and bearing which can indicate whether a wheel hub fastener is properly secured, degree of lubrication, and bearing state of wear), looseness of hub fasteners, wear of brake components (e.g., brake rotor, brake pad, brake drum), a tire condition(s), wear of suspension components, etc. As described above, while systems exist for monitoring many of these components, such systems are typically configured to monitor a single value of a single vehicle component (e.g., tire pressure for a TPMS) or a few values of a single component (e.g., tire pressure and temperature, or bearing health and temperature). Monitoring additional vehicle components using conventional systems can require adding additional sensors, and may require utilizing an additional user interface device associated with a different system.

In some embodiments, mechanisms described herein can facilitate mounting of a sensor(s) in a location (e.g., on a trailer axle) that is removed from moving components, and/or conditions (e.g., high temperatures) that may damage the sensor, while maintaining relatively high accuracy in predicting a state of a vehicle component that is coupled to the component to which the sensor is mounted. In such an example, mechanisms described herein can be sensitive to information in signals from monitored components that are indicative of a state of the monitored components despite distance from the component(s), which can dampen, and/or introduce distortions into, vibrations caused by the monitored vehicle components.

In some embodiments, mechanisms described herein can facilitate monitoring of vehicle components under varied conditions, such as with various amounts of lubrication, various temperatures, various amounts of snow and/or ice (e.g., in contact with the components and/or on the road surface), on various road surfaces, and other conditions. For example, a system that uses more traditional approaches to attempt to detect vehicle component wear or failure based on the presence of particular resonant frequencies and/or amplitudes that exceed a simple threshold can be expected to be less robust to varied conditions, which may cause a change in resonant frequency and/or amplitude that does not accurately reflect the condition of a component that is being monitored.

In some embodiments, mechanisms described herein can utilize a sensor capable of detecting vibrations and/or accelerations that include contributions from a component to which the sensor is mounted, and contributions from components that are physically connected to the component to which the sensor is mounted. For example, a sensor of a system implemented in accordance with mechanisms described herein can be mounted to a non-rotating component of the vehicle that is coupled to rotating components (e.g., via a bearing(s)) and/or non-rotating components that are to be monitored. As another example, a sensor of a system implemented in accordance with mechanisms described herein can be mounted to a rotating component of the vehicle that is coupled to other rotating components and/or non-rotating components (e.g., via a bearing(s)) that are to be monitored. In such an example, the sensor can include, or be coupled to, an independent power source that rotates with the sensor and can communicate with a computing device using wireless communication, and/or can be coupled to a non-rotating power source via a relatively complex rotating interface (which can be used for wired communication).

In some embodiments, a sensor of a system implemented in accordance with mechanisms described herein can condition vibration and/or acceleration signals for transmission to a computing device (e.g., an analyzing unit), for example via a wired connection (though a wireless connection can be used in addition to, or in lieu of, a wired connection). In some embodiments, a computing device of a system implemented in accordance with mechanisms described herein can record incoming conditioned signals (e.g., to memory) for analysis at a later time, for batch analysis, and/or can process conditioned signals in real-time (or near real-time) as the signals are received. In some embodiments, a computing device of a system implemented in accordance with mechanisms described herein can receive signals (e.g., condition signals) from a single vibration sensor or multiple vibration sensors, which can be used to predict a condition of a vehicle component(s). Additionally, in some embodiments, a computing device of a system implemented in accordance with mechanisms described herein can be configured to receive signals from other devices as well (e.g., brake system pressure, brake command status, vehicle speed, vehicle acceleration, total mileage for the vehicle and/or for a specific component, hours of service for the vehicle and/or for a specific component, ambient temperature, etc.), and such signals can be used to determine whether predictions based on received vibration data from a vibration sensor are reliable, whether the vibration data is likely to include data relevant to predicting a state of a particular component(s) (e.g., some components may generate vibrations that are more predictive under certain conditions, and/or may predominantly generate predictive vibrations when actively being used such as brake components).

In some embodiments, mechanisms described herein can include multiple different trained machine learning models that are trained to predict a condition of different vehicle components. Such mechanisms can provide data received from a sensor of a system implemented in accordance with mechanisms described herein to the different trained machine learning models, which can output predictions of a state(s) of particular vehicle components. In some embodiments, signals from one or more other devices (e.g., other than a vibration sensor) can be used to determine which of the trained machine learning models is likely to provide a relevant and/or reliable output based on conditions when the vibration data was recorded.

In some embodiments, a system for predicting a state of a vehicle component(s) described herein can use a refinement process (e.g., executed by a local computing device and/or another computing device which may be local or remote) that analyzes a prediction(s) output by a trained machine learning model(s) to enhance the accuracy and reliability of final predictions generated using the system. For example, the refinement process can use the prediction(s) and temporal and occurrence criteria to determine the final prediction. As another example, the refinement process can incorporate other types of data (e.g., other than vibration data) from another source(s) (e.g., as described above) when determining a final prediction.

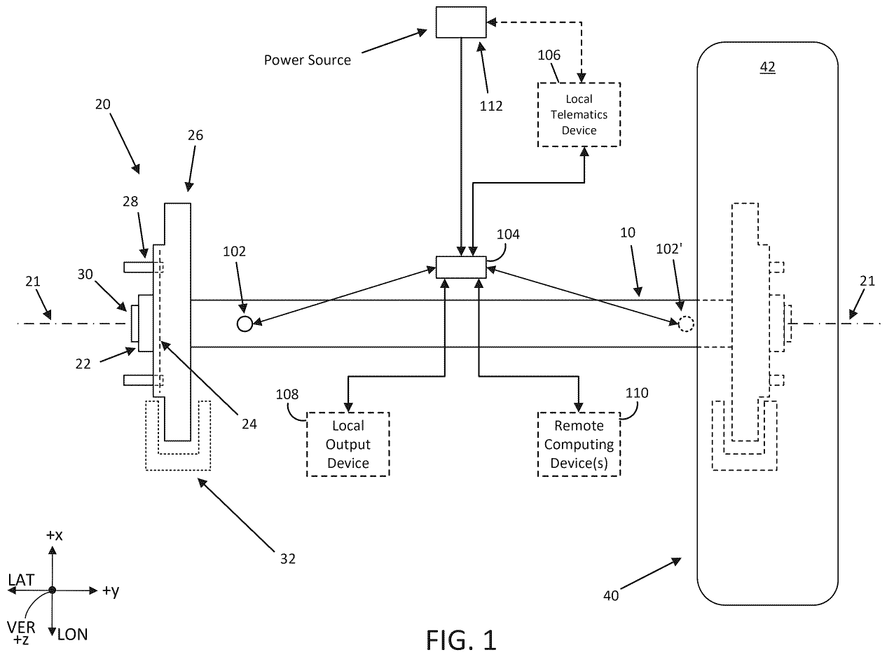

FIG. 1 shows an example of a top view of an axle assembly of a vehicle and a system for monitoring a state of at least one rotating component of the vehicle based on vibration of another component of the vehicle in accordance with some embodiments of the disclosed subject matter. As shown in FIG. 1, the axle assembly can include an axle 10, and a hub assembly 20 that is mounted to a first end of axle 10, and which is configured to allow a wheel to rotate freely about an axis 21 with respect to axle 10. Note that axis 21 of hub assembly 20 may or may not coincide with an axis of axle 10. In some embodiments, hub assembly 20 can include a hub 22 having a flange 24, to which a brake component 26 can be coupled. Alternatively, in some embodiments, brake component 26 can be an integral part of hub 22. As shown in FIG. 1, hub 22 can include multiple wheel studs 28, which can be used to secure a wheel to hub assembly 20. Additionally or alternatively, in some embodiments, hub 22 can include one or more lug holes configured to receive lug bolts, and thereby secure a wheel to hub assembly 20. In some embodiments, a spindle nut 30 can secure hub assembly 20 to axle 10. In some embodiments, one or more additional brake components, such as a brake caliper 32, can be mounted in relatively close proximity to brake component 26, and can be configured to inhibit rotation of brake component 26, thereby inhibiting motion of a wheel secured to hub assembly 20. FIG. 1 also includes an example of a wheel assembly 40 that includes a wheel (not shown) and a tire 42, mounted to a hub assembly at a second end of axle 10. Note that although a wheel assembly including a single wheel is shown in FIG. 1, mechanisms described herein can be used in connection with dual wheel, and/or other configurations.

Note that although FIG. 1 shows an example of a particular axle assembly, mechanisms described herein can be used with axle assemblies having many different configurations. For example, although FIG. 1 shows a trailer axle assembly that has a straight axle, mechanisms described herein can be used in connection with other types of trailer axles, such as drop axles and torsion axles. Additionally, although mechanisms described herein are generally described in connection with trailer axle assemblies, mechanisms described herein can be used in connection with front axles, rear axles, tandem axles, stub axles, live axles, dead axles, etc. For example, many trailer axle assemblies include a static axle component that is does not rotate about axis 21 or a similar axis (though as described below, such an axle component can be configured with other degrees of freedom), which is sometimes referred to as a “dead axle.” In such an example, axle 10 may not include any components that rotate about axis 21 or a similar axis, and vibration sensor 102 can be mounted to any suitable portion of such an axle relatively simply without excessively complicating a link(s) to power, a local computing device(s), etc. As another example, other types of axles can include one or more components that do rotate about axis 21 or a similar axis to provide power to a hub and/or wheel of the axle assembly, which is sometimes referred to as a “live axle.” In such an example, axle 10 may include one or more components that do not rotate about axis 21 (or a similar axis) such as an axle housing, and vibration sensor 102 can be mounted to any suitable non-rotating portion of such an axle relatively simply without excessively complicating connections to power, a local computing device(s), etc. As described below, mounting vibration sensor 102 to a rotating component can increase the cost and/or complexity of mounting and/or powering vibration sensor 102, and/or facilitating communication between vibration sensor 102 and a local computing device(s).

In some embodiments, one or more vibration sensors can be mounted to a static component of an axle assembly, such as a static portion of the axle assembly shown in FIG. 1. For example, as shown in FIG. 1, a vibration sensor 102 can be mounted to a static portion of axle 10 that does not rotate in connection with rotation of a wheel(s) mounted to the axle assembly (e.g., a portion of axle 10 that does not rotate about axis 21, parallel to the y-axis shown in FIG. 1). As described below, mounting vibration sensor 102 to a static portion of an axle assembly can facilitate a wired connection to a power source (e.g., a battery, a generator, etc.) and electronic components to which vibration signals are to be provided. Note that a static portion of axle 10 that does not rotate about axis 21 can be configured to have one or more degrees of freedom, such as along a vertical direction (e.g., along the z-axis shown in FIG. 1) facilitate by a suspension component(s), and/or rotation about a pivot point(s), such as a pivot point(s) that facilitates turning of the axle assembly with respect to the vehicle during a turn (e.g., rotation within an x-y plane) and/or a pivot point(s) that facilitates independent suspension (e.g., rotation of axle 10 or a portion(s) thereof within a z-y plane). Additionally or alternatively, in some embodiments, vibration sensor 102 can be mounted to a rotating portion of an axle assembly, such as a rotating portion of the axle assembly shown in FIG. 1. For example, vibration sensor 102 can be mounted to a portion of hub assembly 20, to a portion of wheel assembly 40, etc. In such an example, vibration sensor 102 can include, and/or be coupled to, a wireless communication system and local power source, as wired connections from rotating components are generally more mechanically complex and more costly than wireless solutions. In some embodiments, vibration sensor 102 can be mounted to a component of an axle assembly using any suitable technique or combination of techniques. For example, vibration sensor 102 can be mounted using an adhesive (e.g., glue, epoxy, etc.), an adhesive tape (e.g., double sided tape), a mechanical fastener(s) that mechanically couples a portion of vibration sensor 102 directly to a component of the axle assembly, a bracket that secures vibration sensor 102 in place in relation to a component of the axle assembly, etc.

Mounting vibration sensor 102 to a static component of the axle assembly that is relatively distal from a hub assembly 20 (e.g., not immediately proximate to hub assembly 20) can protect vibration sensor 102 from inadvertent damage (e.g., from road debris, from debris caught in a wheel, etc.). In some embodiments, different sensor locations can be more suitable for detecting certain conditions, and/or may be less suitable for detecting other conditions. For example, in general, vibration signals recorded closer to a source of the vibration can be expected to be more useful for predicting a state of a component that strongly impacts a characteristic(s) of vibration generated by the source. As a more particular example, a vibration signal collected near the hub (e.g., a vibration sensor mounted on axle 10 relatively close to hub assembly 20) can be expected to be well suited to accurately predicting wheel bearing condition, tire condition, and brake disc (or drum) condition. In such an example, wiring associated with a vibration sensor mounted on an axle near a hub may be relatively difficult to install and/or may be more exposed to environmental hazards (e.g., because the location is closer to the road surface), such as debris strikes, road salt, etc., which may increase costs (e.g., adding a component(s) to protect the wiring and/or sensor, positioning wiring and/or the sensor in a more shielded location which may be more labor intensive to install and/or service, more frequent damage to the sensor and/or wiring) and/or negatively impact reliability of the system (e.g., if the sensor and/or wiring are damaged). As another more particular example, a vibration signal collected near a non-rotating brake system component (e.g., from a vibration sensor mounted to an air disc brake caliper, an air disc brake carrier, or an air disc brake torque plate) can be expected to be well suited to accurately predicting a condition of components of a brake system, but may not be as well suited to accurately predicting tire and hub conditions (e.g., because signals from the tire and hub are more attenuated). In such an example, wiring associated with a vibration sensor mounted on an non-rotating brake system component may be relatively easier to install (e.g., wiring can be routed with air lines connected to the brake chamber of an air disc brake system), and/or may be less exposed to environmental hazards (e.g., because the location is more shielded from the road surface). Additionally, in such an example, a temperature sensor associated with a vibration sensor mounted to a non-rotating brake system component (e.g., a temperature sensor integrated into the vibration sensor, a temperature sensor housed with the vibration sensor, a temperature sensor that shares wiring and/or a wiring route with wiring of the vibration sensor, etc.) can be used to monitor a temperature associated with the brake system (e.g., to collect temperature information from the caliper body of an air disc brake).

In some embodiments, mounting multiple vibration sensors to an axle assembly (e.g., in FIG. 1 vibration sensor 102 is mounted near hub assembly 20 at the first end of axle 10, and a second vibration sensor 102′ can be mounted near wheel assembly 40 at the second end of axle 10), can facilitate independent monitoring of components located closer to both ends of the axle assembly. For example, vibration data from vibration sensor 102 can be used to predict a condition of components closer to the first end and vibration data from vibration sensor 102′ can be used to predict a condition of components closer to the second end, which can facilitate more precise identification of which component(s) a prediction is associated. In a more particular example, if vibration data from vibration sensor 102 predicts a problem with hub assembly 20 (e.g., a loose spindle nut) and vibration data from vibration sensor 102′ does not predict a similar problem with a hub assembly (not labeled) at the second end of axle 10, a user can be informed that a spindle nut associated with a particular hub may be loose, and may be able to more quickly assess whether the prediction is accurate, and if so, correct the loose spindle nut. Note that vibration data from vibration sensor 102 and vibration sensor 102′ can be provided to a common computing device for processing, or different computing devices can be associated with each of vibration sensor 102 and vibration sensor 102′. As another example, a difference(s) between vibration data received from vibration sensor 102 and vibration sensor 102′ (e.g., differences in a frequency domain representation, such as a spectrogram), can be used to facilitate independent monitoring of components located at different positions on the axle assembly. In such an example, if data from vibration sensor 102 includes a strong contribution from a faulty component on the first end of the axle assembly (e.g., caused by an under-torqued spindle nut), data from vibration sensor 102′ can include a contribution from the faulty component on the first end of the axle assembly that may lead to an incorrect prediction (and/or may reduce the confidence of a prediction) associated with a component at the second end of the axle. In a more particular example, a difference(s) between the data from vibration sensor 102 and vibration sensor 102′ can be used to mitigate an impact of cross-talk along the axle (e.g., a difference can be used to identify predictions that are likely to be inaccurate due to cross-talk). As another more particular example, difference(s) between vibration data can be incorporated into training of a machine learning model. In such an example, data can be collected from vibration sensor 102 and vibration sensor vibration sensor 102′ mounted to the same axle assembly with different vehicle component conditions on each end. The data from each vibration sensor can be labeled with the condition at both ends (e.g., a label indication the condition to be predicted, and a potentially confounding condition) and/or different channels of the machine learning model can be trained to predict conditions at a particular end based on data and labels from both ends. Alternatively, in some embodiments, mounting a single vibration sensor to an axle assembly (e.g., near a center of axle 10 between the first end near hub assembly 20 and the second end near wheel assembly 40 in FIG. 1), can facilitate monitoring of components located at both ends of the axle assembly using a single vibration sensor, which can reduce the expense and/or complexity of a system for monitoring a state of at least one vehicle component associated with the axle assembly.

In some embodiments, vibration sensor 102 can be implemented using any suitable vibration sensing component(s) that can produce an electrical signal with a magnitude and/or frequency that modulates with the magnitude and/or frequency at which axle 10 vibrates. For example, vibration sensor 102 can include a vibration-sensitive transducer that generates a modulated electrical signal (e.g., an analog electrical signal) with a magnitude and/or frequency that is based on vibration of a surface of vibration sensor 102. In a more particular example, vibration sensor 102 can be implemented using a piezoelectric sensor configured to output a signal that is based on vibration that is mechanically received at a surface of vibration sensor 102. In such an example, the piezoelectric sensor can be mechanically coupled to a vibration receiving element (e.g., a diaphragm or external contact surface) of vibration sensor 102 such that vibrations received at the vibration receiving element are mechanically transmitted to the piezoelectric sensor, causing the piezoelectric sensor to output a modulated signal that has a magnitude and/or frequency that correspond to vibrations in a medium to which vibration sensor 102 is coupled. In a yet more particular example, vibration sensor 102 can be implemented using a piezoelectric contact microphone (e.g., similar to piezoelectric contact microphones sometimes used to electrify acoustic instruments, such as violins and guitars, such as a Schertler Dyn-Uni-P48 Contact Microphone made available by Schertler SA, headquartered in Mendrisio, Switzerland) with a contact surface of the microphone abutting a surface of axle 10. Note that although vibration sensor 102 is generally described herein as being a piezoelectric microphone, any suitable vibration sensor can be used that is configured to output a modulated electrical signal with properties that reflect vibrations in a surface. For example, vibration sensor 102 can be implemented using a condenser transducer microphone (e.g., similar to condenser microphones sometimes used to electrify acoustic instruments, such as violins and guitars, such as an AKG C411 L mini condenser microphone made available by Harmon International Industries, headquartered in Stamford, Connecticut). In some embodiments, vibration sensor 102 can be a passive sensor and/or can include one or more signal conditioning components (e.g., amplifiers, filters, analog to digital converters, digital signal processors, etc.) configured to improve the quality of the signal produced and/or output by vibration sensor 102, such that a signal received from vibration sensor 102 is a relatively high quality electrical signal (e.g., with a relatively high signal-to-noise ratio) that reflects vibration of one or more components of the axle assembly (e.g., rotating components of the axle assembly such as components of hub assembly 20 and/or wheel assembly 40) with sufficient accuracy to predict a state of at least one rotating component of the vehicle based on vibrations of axle 10 sensed by vibration sensor 102.

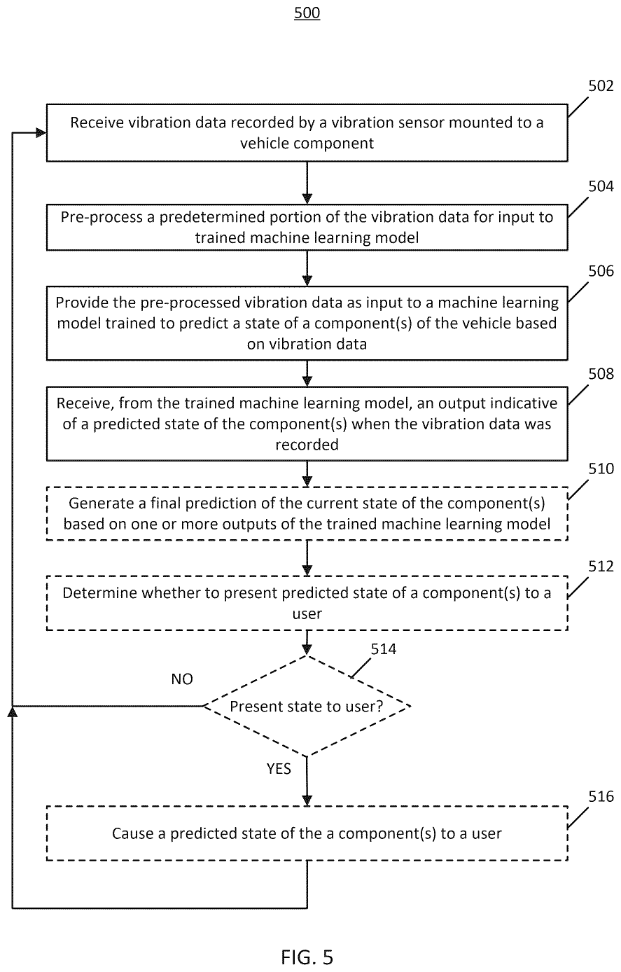

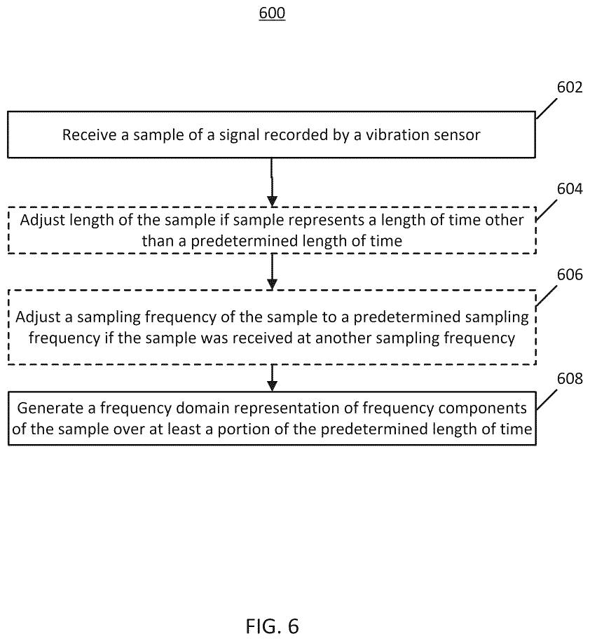

In some embodiments, vibration sensor 102 can be coupled to a local computing device 104 that is configured to receive signals produced by, and/or output by, a vibration sensor(s), and process the received signal(s) into a format that is suitable for use in predicting a state of at least one rotating component of the vehicle based on vibration of the axle (or any other suitable non-rotating component of the vehicle) that is encoded in the received signal (e.g., a spectrogram). For example, local computing device 104 can convert the received vibration signals into a format that is suitable for input to a machine learning model trained to predict a state of a rotating component of the vehicle based on vibration signals recorded from a non-rotating component to which vibration sensor 102 is mounted. In some embodiments, local computing device 104 can receive raw or processed analog signals from one or more vibration sensors 102. Additionally or alternatively, in some embodiments, local computing device 104 can receive raw or processed digital signals from one or more vibration sensors 102. In some embodiments, local computing device 104 can execute at least a portion of a process for predicting a state of at least one rotating component of the vehicle based on the signal(s) received from one or more vibration sensors 102, either alone, or using additional data from one or more other data sources. For example, local computing device 104 can execute at least a portion of process 500 described below in connection with FIG. 5 and/or at least a portion of process 600 described below in connection with FIG. 6. As another example, local computing device 104 can execute an instance of a machine learning model trained to predict a state of at least one rotating component of the vehicle based on vibration of another, non-rotating component of the vehicle that receives and transmits vibrations from the rotating components. As yet another example, local computing device 104 can execute an instance of a machine learning model trained to predict a state of at least one component of the vehicle based on vibration of the component and/or another component of the vehicle coupled to the component, and additional data (e.g., current speed, average speed over a predetermined period of time, acceleration data, temperature, humidity, a brake signal, etc.) that can increase the accuracy of the prediction(s).

In some embodiments, local computing device 104 can be any suitable type of computing device. For example, local computing device 104 can be a special purpose computing device configured to receive data from a vibration sensor(s) mounted on a non-rotating component (e.g., axle 10) and predict a state of at least one rotating component of the vehicle based on vibration data received from the vibration sensors. In such an example, local computing device 104 may or may not be configured for direct user interaction. As another example, local computing device 104 can be a multi-purpose computing device configured to receive data from a vibration sensor(s) mounted on a non-rotating component (e.g., axle 10) and predict a state of at least one rotating component of the vehicle based on, and perform other functions (e.g., local computing device 104 can be at least a portion of an after-market telematics device configured to monitor operation of the vehicle, for example, the trailer to which the vibration sensor is mounted). In such an example, local computing device 104 may or may not be configured for direct user interaction. As yet another example, local computing device 104 can be an embedded multi-purpose computing device configured to receive data from a vibration sensor(s) mounted on a non-rotating component (e.g., axle 10) and predict a state of at least one rotating component of the vehicle based on vibration data received from the vibration sensors, and perform other functions (e.g., local computing device 104 can be at least a portion of an electronic control unit of a tractor to which the axle is coupled and/or to which the trailer including the axle is coupled). In such an example, local computing device 104 may or may not be configured for direct user interaction. As still another example, local computing device 104 can be a general purpose computing device configured to receive data from a vibration sensor(s) mounted on a non-rotating component (e.g., axle 10) and predict a state of at least one rotating component of the vehicle based on vibration data received from the vibration sensors, and perform other functions (e.g., local computing device 104 can be a user device, such as a smartphone, tablet computer, laptop computer, etc.).

In some embodiments, vibration sensor 102, local computing device 104, and/or any other suitable devices can be configured to receive electrical power from a power source 112 that is configured to provide a relatively continuous source of power. For example, power source 112 can include a battery incorporated into and/or mounted to a tractor of a vehicle (e.g., a starter battery, a cycling battery, etc.), a battery incorporated into and/or mounted to a trailer of the vehicle, an auxiliary power unit (APU), a power generating device (e.g., an alternator, a fuel cell, a solar panel, a regenerative braking system, a generator such as a gasoline powered generator, a mechanical generator coupled to a rotating component of the vehicle such as a wheel or hub assembly, etc.), a trailer connector (e.g., a trailer connector complying with the SAE J560 standard, a trailer connector complying with the ISO 1185 standard, etc.), etc.

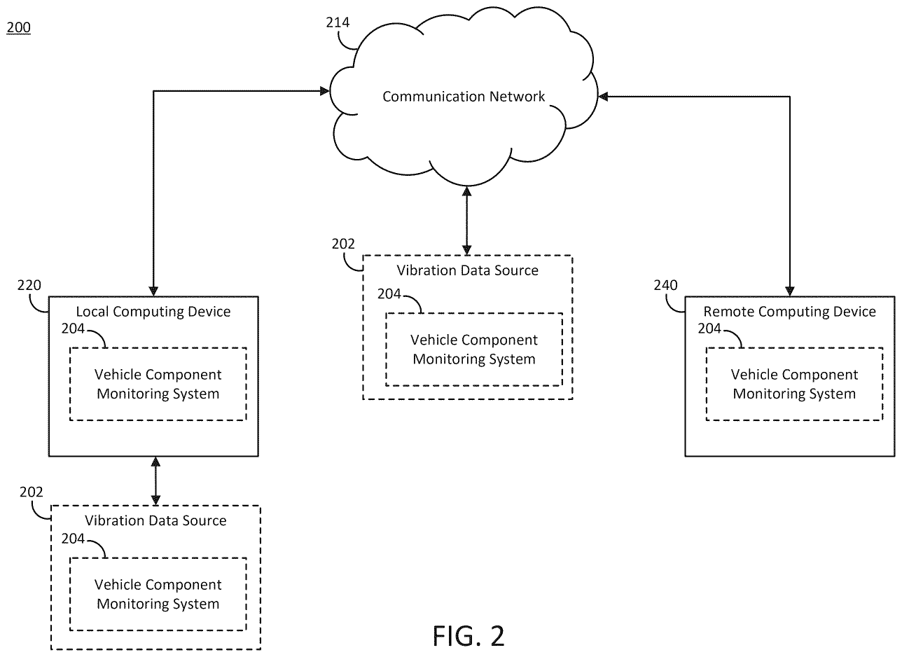

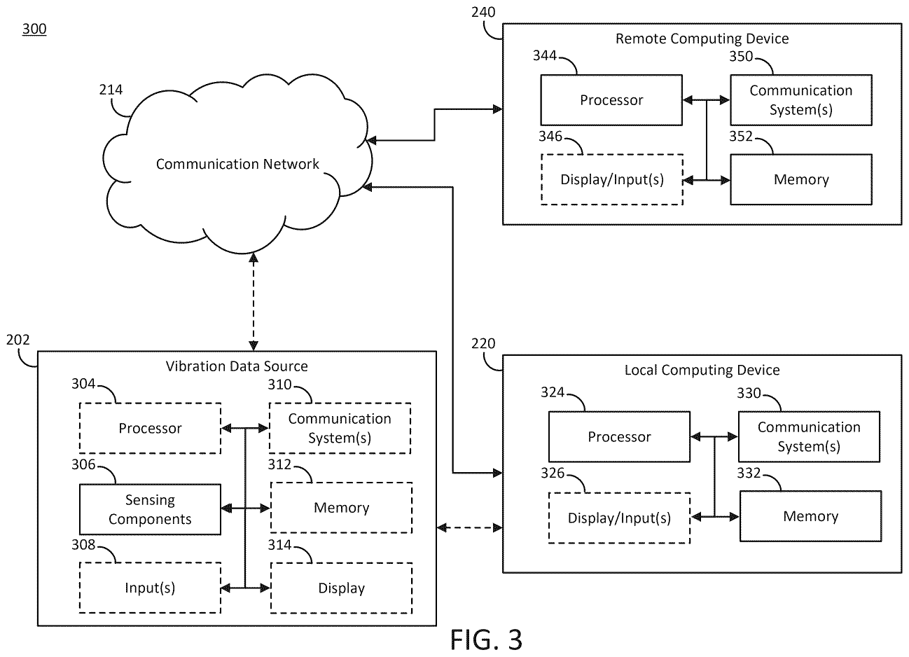

In some embodiments, local computing device 104 can provide data and/or results to a local telematics device 106. In some embodiments, local telematics device 106 can be configured to monitor any suitable characteristics of a vehicle, and can include any suitable type of computing device(s) and/or any suitable sensor(s). For example, local telematics device 106 can be a trailer telematics device configured to monitor a location of a trailer (e.g., using a location sensor, such as a global position system (GPS) receiver) and/or any other suitable trailer characteristics (e.g., speed, an interior temperature, whether a trailer door is open or closed, whether the trailer is connected to an external power source, etc.). In such an example, a trailer telematics system can include an independent power source (e.g., an internal battery which may be rechargeable, a solar panel, etc.) and/or can be coupled to a power source used to provide power to local computing device 104 and/or vibration sensor (e.g., power source 112), and can be configured to collect information about monitored characteristics periodically (e.g., at regular and/or irregular intervals), and periodically (e.g., at regular and/or irregular intervals) communicate information about the monitored characteristics to a remote computing system configured to record and/or analyze telematics information collected from one or more trailers (e.g., using a communication network, such as a communication network described below in connection with FIGS. 2 and 3). As another example, local telematics device 106 can be a tractor telematics device configured to monitor a location of a tractor (e.g., using a location sensor, such as a GPS receiver) and/or any other suitable tractor characteristics (e.g., speed, fuel consumption, diagnostics such as engine faults, etc.). In such an example, a tractor telematics system can include an independent power source or be powered from an electrical system of the tractor, can be configured to collect information about monitored characteristics periodically, and can periodically communicate information about the monitored characteristics to a remote computing system configured to record and/or analyze telematics information collected from one or more trailers (e.g., using a communication network, such as a communication network described below in connection with FIGS. 2 and 3). In some embodiments, local telematics device 106 can be integrated into a portion of a vehicle (e.g., a tractor, a trailer, etc.) during manufacturing (e.g., local telematics device 106 can be installed by an original equipment manufacturer (OEM)), or can be an aftermarket device coupled to a portion of the vehicle (e.g., by a dealer, wholesaler, buyer, fleet operator, etc.).

In some embodiments, local computing device 104 can use a local output device 108 to present information about a state of at least one rotating component of a vehicle associated with local computing device 104 and/or local output device 108. In some embodiments, local output device 108 can any suitable type of output device. For example, local output device 108 can be a special-purpose output device configured to inform a user about the predicted state of a component(s) of the vehicle. In a more particular example, local output device 108 can be a visual indicator (e.g., an indicator light, indicator gauge, etc.) that is located where a user (e.g., a driver in a cab of the vehicle being monitored using vibration sensor 102) is likely to notice (e.g., see) a visual indicator of the predicted state of the component(s) of the vehicle (e.g., a rotatable component(s) of the vehicle), such that local output device 108 can be used to alert the user to the predicted state of a vehicle component(s). As another more particular example, local output device 108 can be a non-visual indicator (e.g., a haptic feedback device, an audio device, etc.) that is located where a user is likely to notice (e.g., feel, hear) a non-visual indicator of the predicted state of the component(s) of the vehicle, such that local output device 108 can be used to alert the user to the predicted state of the component(s). As another example, local output device 108 can be a multi-purpose output device configured to inform a user about the predicted state of the component(s) of the vehicle, and perform other functions. As a more particular example, local output device 108 can be part of an in-vehicle information system (e.g., part of a dashboard, an infotainment system, etc.). As yet another example, local output device 108 can be a general purpose user interface device (e.g., a smartphone, a wearable computing device, tablet computer, laptop computer, etc.), which can be configured to inform a user about the predicted state of the component(s) of the vehicle, and perform other functions. As a more particular example, local output device 108 can be a user device that is connected to local computing device 104 (e.g., via a local wired or wireless communications link), and that can be configured to present information about the predicted state of the component(s) of the vehicle in response to receiving a signal (e.g., including data and/or instructions), such as a notification(s) (e.g., a visual pop-up notification, an audio notification, etc.).

In some embodiments, local computing device 104 can provide data and/or results to a remote computing device 110. In some embodiments, remote computing device 110 can any suitable type of computing device that is physical and/or logically remote. For example, remote computing device 110 can be a server computer (e.g., a server of a cloud computing service, a server of a telematics system, etc., which may be a physical server and/or a virtual machine), a smartphone, a tablet computer, a wearable computer, etc., configured to receive data and/or results from a local computing device (e.g., local computing device 104, local telematics device 106) related to a component(s) of a particular vehicle (e.g., a vehicle associated with axle 10) and/or a predicted state of a component(s) of the vehicle. In a more particular example, remote computing device 110 can be a computing device(s) executing a backend of a vehicle component monitoring system having a frontend that is being executed, at least in part, at local computing device 104. In a more particular example, local computing device 104 can collect data (e.g., from vibration sensor(s) 102) and/or generate results (e.g., a predicted state of a component(s) of the vehicle) based on received data. As another more particular example, remote computing device 110 can be a computing device(s) executing a backend of a vehicle monitoring system (e.g., a telematics system) having a frontend that is being executed, at least in part, at local computing device 104 and/or another local computing device.

In some embodiments, remote computing device 110 can be configured to receive data based on signals produced by, and/or output by, a vibration sensor(s) (e.g., vibration sensor 102), and process the received signal(s) into a format that is suitable for use in predicting a state a component(s) of a vehicle based on vibration of a component coupled thereto that is encoded in the received signal (e.g., a spectrogram). For example, remote computing device 110 can receive data (e.g., digital and/or analog values in which information from the vibration data collected by vibration sensor 102 is encoded) from local computing device 104 (and/or local telematics system 106), and can convert the received vibration data into a format that is suitable for input to a machine learning model trained to predict a state of a component(s) of the vehicle based on vibration signals recorded from a particular component of the vehicle. In some embodiments, remote computing device 110 can execute at least a portion of a process for predicting a state of a component(s) of the vehicle based on the signal(s) received from one or more vibration sensors 102 (e.g., received via local computing device 104, local telematics device 106, etc.), either alone, or using additional data from one or more other data sources. For example, remote computing device 110 can execute at least a portion of process 500 described below in connection with FIG. 5 and/or at least a portion of process 600 described below in connection with FIG. 6. As another example, remote computing device 110 can execute an instance of a machine learning model trained to predict a state of a vehicle component(s) based on vibration of a component coupled thereto. Additionally or alternatively, in some embodiments, remote computing device 110 can be configured to receive a result(s) (e.g., a predicted state of a component(s)), and cause information based on the result to be presented to a user (e.g., a driver of the vehicle, an owner of the tractor and/or trailer that includes the monitored component(s) of the vehicle, a user associated with a fleet operator that manages a fleet that includes the tractor and/or trailer that includes the monitored component(s)). For example, remote computing device 110 can be configured to provide access to a predicted state of the component(s) (e.g., to a fleet operator, a driver, and/or any other suitable authorized user of a vehicle component monitoring system and/or vehicle monitoring system). As another example, remote computing device 110 can be configured to cause an alert to be presented to a user based on the predicted state of the monitored component(s).

FIG. 2 shows an example of a system 200 for monitoring a state of at least one rotating component of the vehicle in accordance with some embodiments of the disclosed subject matter. As shown in FIG. 2, a vibration data source 202 can generate vibration data based on vibration of a component of the vehicle (e.g., using vibration sensor 102 and/or a computing device that receives data from vibration sensor 102), and can provide the vibration data (e.g., as raw vibration data, processed vibration data, pre-processed vibration data, etc.) to a local computing device 220 and/or a remote computing device 240 directly and/or indirectly using a communication network 214. In some embodiments, the vibration data generated by vibration data source 202 can be based on vibration of a non-rotating component (e.g., axle 10) that is mechanically coupled to one or more rotating components (e.g., components of a hub assembly, a wheel assembly, etc.). In some embodiments, local computing device 220 can execute at least a portion of a vehicle component monitoring system 204 to predict a state of a component(s) of the vehicle based on vibrations generated by the component (e.g., recorded and/or processed via vibration data source 202). Additionally or alternatively, in some embodiments, vibration data source 202 and/or local computing device 220 can communicate vibration data (e.g., data generated by vibration data source 202) to a remote computing device 240 over communication network 214, and remote computing device 240 can execute at least a portion of vehicle component monitoring system 204 to predict a state of the component(s). Additionally or alternatively, in some embodiments, vibration data source 202 can execute at least vehicle component monitoring system 204 to predict a state of the component(s), and can communicate vibration data (e.g., raw vibration data, pre-processed vibration data, etc.) and/or results (e.g., a predicted state of a component(s)) to local computing device 220 and/or remote computing device 240. In some embodiments, vehicle component monitoring system 204 can execute one or more portions of process 500 described below in connection with FIG. 5 and/or at least a portion of process 600 described below in connection with FIG. 6. For example, vehicle component monitoring system 204 can be executed by a single computing device (e.g., local computing device 220, remote computing device 240, or vibration data source 202), or can be executed as a distributed system (e.g., a distributed application, a cloud application) across a combination of computing devices (e.g., by local computing device 220, remote computing device 240, vibration data source 202, and/or any other suitable computing device(s)).

In some embodiments, vehicle component monitoring system 204 can receive vibration data (e.g., generated by, and/or received from, vibration data source 202), and can predict a state of a component(s) of a vehicle based on the vibration data, either alone, or in combination with any other suitable data from one or more other data sources. For example, local computing device 220 can receive vibration data from vibration data source 202, and predict a state of a component(s) of the vehicle based on the vibration data. In such an example, local computing device 220 can present information indicative of the predicted state of the component(s) (e.g., via an output device of local computing device 220, or via another local output device such as local output device 108). Additionally or alternatively, in such an example, local computing device 220 can transmit information indicative of the predicted state of the component(s) (e.g., via communication network 214) to another device (e.g., remote computing device 240).

As another example, local computing device 220 can receive vibration data from vibration data source 202, transmit the vibration data and/or processed vibration data based on the vibration data (e.g., pre-processed vibration data) to remote computing device 240, and remote computing device 240 can predict a state of the component(s) of the vehicle based on the vibration data. In such an example, remote computing device 240 can present information indicative of the predicted state of the component(s) (e.g., via an output device of remote computing device 240, or via another local output device such as local output device 108). Additionally or alternatively, in such an example, remote computing device 240 can transmit information indicative of the predicted state of the component(s) (e.g., via communication network 214) to another device (e.g., back to local computing device 220, to another remote computing device, etc.).

As yet another example, remote computing device 240 can receive vibration data from vibration data source 202 (e.g., via communication network 214), and can predict a state of the component(s) based on the vibration data. In such an example, remote computing device 240 can present information indicative of the predicted state of the component(s) (e.g., via an output device of remote computing device 240, or via another local output device such as local output device 108). Additionally or alternatively, in such an example, remote computing device 240 can transmit information indicative of the predicted state of the component(s) (e.g., via communication network 214) to another device (e.g., local computing device 220, another remote computing device, etc.), which can present the information indicative of the predicted state of the component(s) and/or permit access to the information indicative of the predicted state of the component(s).

As still another example, vibration data source 202 can predict a state of the component(s) based on the vibration data. In such an example, vibration data source 202 can provide information indicative of the predicted state of the component(s) to local computing device 220, remote computing device 240, and/or an output device (e.g., local output device 108), which can present the information indicative of the predicted state of the component(s) and/or permit access to the information indicative of the predicted state of the component(s).

In some embodiments, local computing device 220 and/or remote computing device 240 can be any suitable computing device or combination of devices, such as a desktop computer, a laptop computer, a smartphone, a tablet computer, a wearable computer, a server computer, a virtual machine being executed by a physical computing device, an embedded controller (e.g., an electronic control unit), a microcontroller, etc. Laptop computers, smartphones, tablet computers, and wearable computers are all examples of mobile computing devices.

In some embodiments, vibration data source 202 can be any suitable source of vibration data and/or other data that can be used to predict a state of a component(s) of a vehicle as described herein. For example, vibration data source 202 can be implemented using one or more vibration sensors (e.g., as described above in connection with vibration sensor 102) configured to measure vibration of, and/or vibration within, one or more non-rotating components (e.g., axle 10, a brake caliper, a brake drum, a suspension component(s), etc.) and/or one or more rotating components (e.g., components of a hub assembly, components of a wheel assembly, etc.). As another example, vibration data source 202 can be a computing device(s) and/or data storage device(s) used to collect and/or store vibration data for a component(s) being monitored (e.g., raw vibration data, spectrograms, etc.), such as a database server(s), or network storage (e.g., a private storage device connected to network 214, a cloud storage device connected to network 214, etc.). Note that although vibration data source 202 is described in connection with providing vibration data of a vehicle component, vibration data source 202 can also be a source of other data, such as telematics data (e.g., speed, location, on-board diagnostics, etc.) for a vehicle or portion of a vehicle (e.g., vibration sensor 102 can be connected to a portion of a trailer telematics system, a tractor telematics system, etc.), etc.

In some embodiments, vibration data source 202 can be local to local computing device 220 (e.g., physically and logically). For example, vibration data source 202 can be incorporated with local computing device 220 (e.g., vibration data source 202 can be configured as a device or part of a device for capturing, storing, and/or processing vibration data). As another example, vibration data source 202 can be connected to local computing device 220 by a cable, a direct wireless link, etc. Additionally or alternatively, in some embodiments, vibration data source 202 can be located locally and/or remotely from local computing device 220, and can communicate vibration data to local computing device 220 (and/or remote computing device 240) via a communication network (e.g., communication network 214).

In some embodiments, communication network 214 can be any suitable communication network or combination of communication networks. For example, communication network 214 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, 5G NR, etc.), a wired network, etc. In some embodiments, communication network 214 can include one or more portions of a local area network (LAN), a wide area network (WAN), a public network (e.g., the Internet, which may be part of a WAN and/or LAN), any other suitable type of network, or any suitable combination of networks. Communications links shown in FIGS. 1 to 3 can each be any suitable communications link or combination of communications links, such as wired links, fiber optic links, Wi-Fi links, Bluetooth links, cellular links, etc.

FIG. 3 shows an example of hardware 300 that can be used to implement a vibration data source 202, a local computing device 220, and a remote computing device 240 of FIG. 2 in accordance with some embodiments of the disclosure. As shown in FIG. 3, in some embodiments, vibration data source 202 can include a processor 304, sensing components 306, one or more inputs 308, one or more communication system(s) 310, memory 312, and/or a display(s) 314.

In some embodiments, processor 304 can be any suitable hardware processor or combination of processors, such as a central processing unit (CPU), an accelerated processing unit (APU), a graphics processing unit (GPU), a field programmable gate array (FPGA), an application specific integrated circuit (ASIC), a microcontroller, etc.

In some embodiments, sensing components 306 can include components that can be used to detect vibrations (e.g., of a vibration sensing component of a vibration sensor) and convert the detected vibrations into electrical signals, such as one or more piezoelectric sensors (and/or any other type of suitable vibration sensing component(s), such as vibration sensing components described above in connection vibration sensor 102 of FIG. 1) that can be used to detect vibrations of a surface and/or object, and/or vibrations within a material, that vibration data source 202 is configured to monitor (e.g., along one or more axes). In some embodiments, sensing components 306 can include one or more passive components (e.g., components that do not require an external power source) such as one or more piezoelectric sensors, passive circuit components (e.g., wires, traces, resistors, capacitors, inductors, etc.), and/or one or more active components (e.g., one or more amplifiers, active filters, analog-to-digital converters, digital signal processors, etc.). In some embodiments, a vibration component can be a passive or active component, and a signal produced by the vibration component may or may not be conditioned prior to being recorded (e.g., in memory) and/or output (e.g., via communication system(s) 310).

In some embodiments, inputs 308 can include any suitable input devices and/or sensors that can be used to receive user input, such as a keyboard, a mouse, a touchscreen, a touchpad, a microphone, a camera, etc. In some embodiments, display 314 can include any suitable display devices, such as a touchscreen, a computer monitor, a television, etc. Additionally, vibration data source 202 can include a non-visual output(s) in addition to, or in lieu of, display 314, such as a haptic feedback device, an audio device, etc. In some embodiments, vibration data source 202 can omit sensing components 306, inputs 308, and/or a display(s) 314 (e.g., where vibration data source 202 is not configured for direct user interaction, and/or where vibration data source 202 is a computing device that receives vibration data from a separate vibration sensor, and is not configured for direct user interaction such as a server of a cloud storage service provider).

In some embodiments, communication system(s) 310 can include any suitable hardware, firmware, and/or software for communicating information over communication network 214 and/or any other suitable communication networks. For example, communication system(s) 310 can include one or more transceivers, one or more communication chips and/or chip sets, etc., that can be used to establish a wired and/or wireless communication link. In a more particular example, communication system(s) 310 can include hardware, firmware, and/or software that can be used to establish a direct or indirect wired connection and/or a direct or indirect wireless connection, such as a wired connection (e.g., an analog connection, a digital connection such as a universal serial bus (USB) connection, a controller area network (CAN) bus connection), a Bluetooth connection, Bluetooth Low Energy connection, an ultrawideband (UWB) connection, a ZigBee connection, a Wi-Fi connection, a cellular connection (e.g., an uplink connection, a downlink connection, or a sidelink connection), an Ethernet connection, etc.

In some embodiments, memory 312 can include any suitable storage device or devices that can be used to store instructions, values, etc., that can be used, for example, by processor 304 to perform processes described herein, to detect and/or record data, to store data, to retrieve data, to transmit data, to analyze data, etc., to communicate with local computing device 220 and/or remote computing device 240 via communication system(s) 310, etc. Memory 312 can include any suitable volatile memory, non-volatile memory, storage, or any suitable combination thereof. For example, memory 312 can include random access memory (RAM), read-only memory (ROM), electronically erasable programmable read-only memory (EEPROM), one or more flash drives, one or more hard disks, one or more solid state drives, one or more optical drives, etc.

In some embodiments, memory 312 can have encoded thereon a computer program for controlling operation of vibration data source 202. In such embodiments, processor 304 can execute at least a portion of the computer program to: record raw vibration data in memory 312; process vibration data (e.g., pre-process vibration data as described below); generate one or more condensed representations of the vibration data (e.g., a spectrogram); store condensed representations of the vibration data in memory 312; retrieve vibration data and/or condensed representation(s) of vibration data from storage in memory 312; to transmit information (e.g., raw vibration data, processed vibration data, condensed vibration data, and/or other data) to local computing device 220 and/or remote computing device 240; to execute at least a portion of a process for predicting a state of one or more vehicle components based on vibration generated by the component(s), such as one or more portions of processes described below in connection with FIGS. 5 and 6, etc.

In some embodiments, local computing device 220 can include a processor 324, a display and/or inputs 326, one or more communication system(s) 330, and/or memory 332. In some embodiments, processor 324 can be any suitable hardware processor or combination of processors, such as a CPU, an APU, a GPU, an FPGA, an ASIC, a microcontroller, etc.

In some embodiments, display/inputs 326 can include any suitable display devices, such as a computer monitor, a touchscreen, a television, etc., and/or any suitable input devices/sensors that can be used to receive user input, such as a keyboard, a mouse, a touchscreen, a microphone, etc. In some embodiments, local computing system 220 can omit a display and/or inputs (e.g., where local computing system 220 is an embedded device that is not configured for direct user interaction).

In some embodiments, communication system(s) 330 can include any suitable hardware, firmware, and/or software for communicating information over communication network 214 and/or any other suitable communication networks. For example, communication system(s) 330 can include one or more transceivers, one or more communication chips and/or chip sets, etc., that can be used to establish a wired and/or wireless communication link. In a more particular example, communication systems 330 can include hardware, firmware, and/or software that can be used to establish a direct or indirect wired connection and/or a direct or indirect wireless connection, such as a wired connection (e.g., an analog connection, a digital connection such as a USB connection, a CAN bus connection), a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 332 can include any suitable storage device or devices that can be used to store instructions, values, etc., that can be used, for example, by processor 324 to perform processes described herein, to receive and/or record data, to store data, to retrieve data, to transmit data, to analyze data, etc., to communicate with vibration data source 202 and/or remote computing device 240 via communication system(s) 330, to receive user input (e.g., via display/inputs 326), to present information and/or a UI to a user (e.g., via display/inputs 326), etc. Memory 332 can include any suitable volatile memory, non-volatile memory, storage, or any suitable combination thereof. For example, memory 332 can include RAM, ROM, EEPROM, one or more flash drives, one or more hard disks, one or more solid state drives, one or more optical drives, etc.

In some embodiments, memory 332 can have encoded thereon a computer program for controlling operation of local computing device 220. In such embodiments, processor 324 can execute at least a portion of the computer program to: receive raw and/or processed vibration data; record raw vibration data in memory 332; process vibration data (e.g., pre-process vibration data as described below); generate one or more condensed representations of the vibration data (e.g., a spectrogram); store condensed representations of the vibration data in memory 332; retrieve vibration data and/or condensed representations of vibration data from storage in memory 332; to transmit information (e.g., raw vibration data, processed vibration data, condensed vibration data, and/or other data) to remote computing device 240 and/or another local computing device; to execute at least a portion of a process for predicting a state of one or more vehicle components based on vibration generated by the component(s), such as one or more portions of processes described below in connection with FIGS. 5 and 6, etc.

In some embodiments, remote computing device 240 can include a processor 344, a display and/or input(s) 346, a communication system(s) 350, and/or memory 352. In some embodiments, processor 344 can be any suitable hardware processor or combination of processors, such as a CPU, an APU, a GPU, an FPGA, an ASIC, a microcontroller, etc.

In some embodiments, display/input 346 can include any suitable display devices, such as a computer monitor, a touchscreen, a television, etc., and/or can include any suitable input devices and/or sensors that can be used to receive user input, such as a keyboard, a mouse, a touchscreen, a microphone, etc. In some embodiments, remote computing device 240 can omit display/inputs 346 (e.g., where remote computing device 240 is not configured for direct user interaction, such as if remote computing device 240 is a backend device and/or an embedded device).

In some embodiments, communication system(s) 350 can include any suitable hardware, firmware, and/or software for communicating information over communication network 214 and/or any other suitable communication networks. For example, communication system(s) 350 can include one or more transceivers, one or more communication chips and/or chip sets, etc., that can be used to establish a wired and/or wireless communication link. In a more particular example, communication system(s) 350 can include hardware, firmware, and/or software that can be used to establish a direct or indirect wired connection and/or a direct or indirect wireless connection, such as a CAN bus connection, a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 352 can include any suitable storage device or devices that can be used to store instructions, values, etc., that can be used, for example, by processor 344 to perform processes described herein, to receive and/or record data, to store data, to retrieve data, to transmit data, to analyze data, etc., to communicate with vibration data source 202 and/or local computing device 220 via communication system(s) 350, to receive user input (e.g., via display/inputs 346), to present information and/or a UI to a user (e.g., via display/inputs 346), etc. Memory 352 can include any suitable volatile memory, non-volatile memory, storage, or any suitable combination thereof. For example, memory 352 can include RAM, ROM, EEPROM, one or more flash drives, one or more hard disks, one or more solid state drives, one or more optical drives, etc.

In some embodiments, memory 352 can have encoded thereon a computer program for controlling operation of remote computing device 240. In such embodiments, processor 344 can execute at least a portion of the computer program to: receive raw and/or processed vibration data; record raw vibration data in memory 352; process vibration data (e.g., pre-process vibration data as described below); generate one or more condensed representations of the vibration data (e.g., a spectrogram); store condensed representations of the vibration data in memory 352; retrieve vibration data and/or condensed representations of vibration data from storage in memory 352; to transmit information (e.g., raw vibration data, processed vibration data, condensed vibration data, and/or other data) to local computing device 220; to execute at least a portion of a process for predicting a state of one or more vehicle components based on vibration generated by the component(s), such as one or more portions of processes described below in connection with FIGS. 5 and 6, etc.

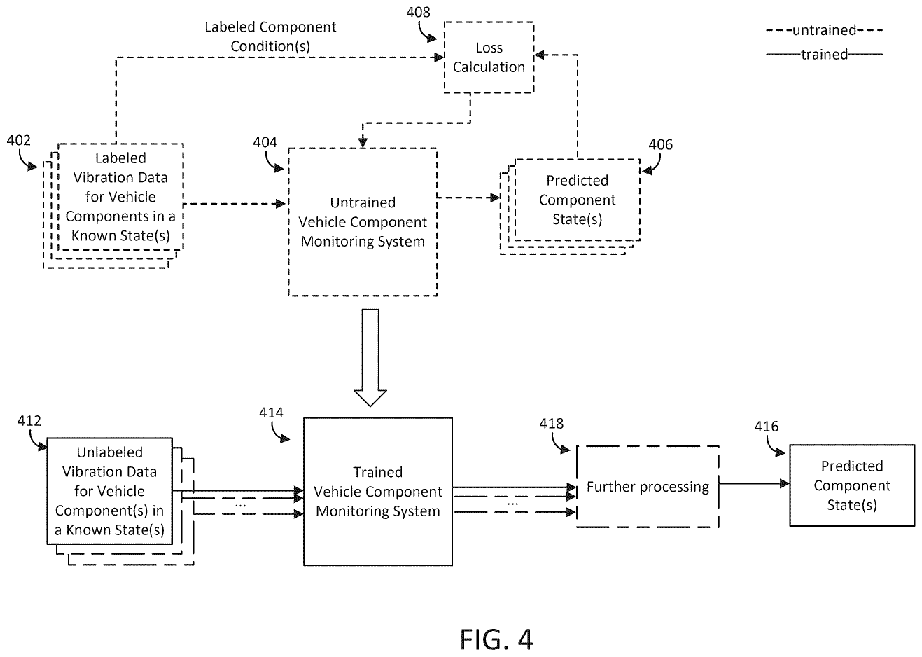

FIG. 4 shows an example of a flow 400 for training and using mechanisms for monitoring a rotating component of a vehicle based on vibration of a component coupled thereto in accordance with some embodiments of the disclosed subject matter. As shown in FIG. 4, labeled vibration data 402 can be used as training data during a training procedure for an untrained vehicle component monitoring system 404. For example, each labeled vibration sample in labeled vibration data 402 can be associated with one or more labels, each indicating a known state of one or more vehicle components (e.g., one or more rotating vehicle components) when the data used to generate the vibration sample was recorded. In such an example, the known state(s) associated with a particular labeled vibration sample can be used as a label during training to determine performance of untrained vehicle component monitoring system 404 during training. In some embodiments, when one or more conditions have been satisfied during training (e.g., a predetermined level of performance has been achieved, a predetermined number of training epochs have been completed, performance improvement between training batches and/or epochs has decreased below a predetermined threshold, etc.), training can be considered complete, and untrained vehicle component monitoring system 404 can be deployed as a trained vehicle component monitoring system 414. In some embodiments, additional data can be included in a label(s), such as a value indicative of a vehicle speed when the sample was recorded, average vehicle speed when the sample was recorded, temperature, humidity, a status of a brake signal, etc., and can be used in connection with training a machine learning model(s) (e.g., additional data can be provided as input during training) and/or can be used to evaluate reliability of the machine learning model (e.g., additional data can be used to determine whether there is a pattern linking incorrect predictions about a state of a component with a value of additional data). For example, vibration data collected while a trailer is stationary may not be useful for accurately predicting a state of a component, and vehicle speed may be expected to be inversely correlated with prediction accuracy for some components (e.g., rotating components). In a more particular example, if a machine learning model that is being trained to predict a state of a trailer tire, and predicts a state of a trailer tire as properly inflated based on input vibration data labeled as being from an axle assembly with a flat tire, the prediction is incorrect. However, treating such a prediction during training may not add value to a training process, as the input may not include enough information about the state of the tire to allow the machine learning model to make an accurate prediction (e.g., training based on such incorrect predictions may lead to degraded performance of a trained machine learning model). In such an example, vehicle speed can be used to determine whether to provide vibration data as an input during training and/or to a trained machine learning model. Additionally or alternatively, vehicle speed associated with a sample of vibration data can be used to inform a confidence of a prediction based on the sample of vibration data.

In some embodiments, labeled vibration data 402 can include data corresponding to one particular type and/or configuration of vehicle, and/or can include data for multiple different types and/or configurations of vehicle. For example, a machine learning model trained using labeled vibration data 402 can be trained for use with vehicles having components (e.g., an axle assembly) that are similar to components reflected in the training data. In such an example, multiple machine learning models can be trained using different sets of labeled vibration data associated with different types and/or configurations of vehicle, and a machine learning model used to predict a state of a vehicle component(s) of a particular vehicle can be selected (e.g., manually via user input or automatically) based on a component(s) of the particular vehicle. As another example, a machine learning model trained using labeled vibration data 402 can be trained for use with multiple different types and/or configurations of vehicles. In such an example, predictions by such a trained machine learning model can be evaluated for different types and/or configurations of vehicle, and the model can be indicated as useable with vehicle types and/or configurations for which performance of the trained machine learning model is acceptable (e.g., above a threshold). In some embodiments, the vibration data can be collected at a particular sampling rate (e.g., 44.1 kilohertz (kHz), 48 kHz, 96 kHz, etc.), and labeled vibration data 402 can represent the collected vibration data at the same rate at which it was collected, or at a different rate. For example, if vibration data is collected at a relatively high sampling rate (e.g., 92 kHz, 96 kHz, or higher), the vibration data can be down sampled to a lower sampling rate (e.g., 10 kHz, 12 kHz, 24 kHz, 48 kHz, etc.), and each labeled vibration sample in labeled vibration data 402 can be based on the down sampled data.

In some embodiments, labeled vibration data 402 can include a label associated with a condition of one particular component or set of components (e.g., a state of a lug fastener(s) and/or a hub fastener(s) associated with the axle assembly, a state of a bearing(s), a state of a brake pad(s), a state of a brake drum(s), etc.), and/or can include labels associated with conditions of multiple different components or sets of components. In some embodiments, a machine learning model can be trained to predict a state of one particular component or set of components associated with an axle assembly. For example, a machine learning model trained using labeled vibration data 402 can be trained to predict a state of a set of lug fasteners associated with one side of an axle assembly (e.g., whether the lug nuts used to secure a wheel assembly to the hub on a closest side of the axle assembly are properly torqued or improperly torqued) based on respective labels associated with samples of labeled vibration data 402 indicating a state of the lug fasteners (e.g., on one side, or both sides, or as a set) on the axle assembly from which the vibration data was recorded. In such an example, a first machine learning model can be trained using a first set of labeled vibration data associated with various states of lug fasteners (e.g., a set of samples of labeled vibration data collected from axle assemblies with a state of the lug fasteners varied, with the states of all other components maintained in the same condition) to predict a state of lug fasteners, and other machine learning models can be trained using other sets of labeled vibration data associated with various states of other particular components (e.g., a hub fastener(s), a bearing(s), a tire, etc., with the states of all other components maintained in the same condition) to predict a state of the other particular components. Additionally or alternatively, in such an example, a first machine learning model can be trained using a set of labeled vibration data associated with various states of lug fasteners and various states of other particular components (e.g., a set of samples of labeled vibration data collected from axle assemblies with a state of the lug fasteners varied, and with the states of various other components varied as well) to predict a state of lug fasteners, and other machine learning models can be trained using the same set of labeled vibration data associated with various states of the hub fasteners and other particular components to predict a state of the other particular components. As another example, a machine learning model trained using labeled vibration data 402 can be trained to predict a state of a set(s) of lug fasteners associated with an axle assembly and a state one or more other components, such as a state of a brake pad(s) (e.g., a state of wear of the brake pad) based on respective labels associated with samples of labeled vibration data 402 indicating a state of the lug fasteners (e.g., on one side, or both sides, or as a set) on the axle assembly from which the vibration data was recorded, and labels associated with samples of labeled vibration data 402 indicating a state of the brake pads. In such an example, one machine learning model can be trained using a labeled vibration data associated with various states of the lug fasteners and brake pads (e.g., a set of samples of labeled vibration data collected from axle assemblies with a state of the lug fasteners varied and the state of the brake pad(s) varied, with the states of all other components maintained in the same condition or varied) to predict a state of lug fasteners, a state of a brake pad(s), and/or any other suitable component(s), and other machine learning models can be trained using the same and/or other sets of labeled vibration data associated with various states of other particular components (e.g., a hub fastener(s), a bearing(s), a tire, etc., with the states of all other components maintained in the same condition) to predict states of other particular components. In some embodiments, the label(s) associated with a sample of labeled vibration data 402 can be in any suitable format, such as a Boolean label, a labeled discrete level from a set of levels, a discrete variable, a continuous variable, etc. As a more particular example, a machine learning model can be trained using labeled vibration data collected from axle assemblies having different axle geometries (e.g., different axle types, different axle configurations) and/or bearings from different manufacturers, and such a model can be trained to predict a state of vehicle components (e.g., bearing health, hub fastener condition, lug fastener condition) regardless of the particular axle geometry or bearing manufacturer. In some embodiments, training a machine learning model using vibration data from a variety of axle geometries and bearing manufacturers can result in a model that generalizes across different hardware configurations, which can reduce the need to train separate models for each axle type or bearing manufacturer.

In some embodiments, labeled vibration data 402 can be generated using any suitable source of data and/or any suitable technique or combination of techniques. In some embodiments, a vehicle (or portion thereof) having an axle assembly (or multiple axle assemblies) equipped with one or more vibration sensors (e.g., as described above in connection with vibration sensor 102 of FIG. 1) can be operated (e.g., driven along a route having one or more driving surfaces) under known conditions of components of the axle assembly, while vibration data is collected using the vibration sensor(s). Additionally, in some embodiments, an axle assembly, portion of an axle assembly, multiple axle assemblies, etc., equipped with one or more vibration sensors (e.g., as described above in connection with vibration sensor 102 of FIG. 1) can be operated in a controlled environment (e.g., using a dynamometer, rollers, a rolling road, etc.) under known conditions of components of the axle assembly, while vibration data is collected using the vibration sensor(s). In some embodiments, vibration data collected using the vibration sensor(s) can be labeled based on the known condition(s) of the vehicle, one or more components of the axle assembly, and/or an operation(s) that was performed while the vibration data was being recorded.

In some embodiments, any suitable condition(s) of components of the axle assembly (and/or other components of a vehicle) can be varied in connection with generation of labeled vibration data 402. For example, a condition of one or more mechanical connections securing components of the axle assembly can be varied. In a more particular example, a tightness (or looseness) of one or more lug fasteners (e.g., based on a torque to which one or more lug notes and/or lug bolts was tightened) can be varied in connection with collection of different vibration samples. In such an example, one or more lug fasteners can be under-torqued, properly torqued, and/or over-torqued when securing a wheel assembly to a hub assembly, and vibration data can be collected for various different states of the lug fasteners. As another more particular example, a tightness (or looseness) of one or more hub fasteners used to secure a hub assembly to an axle (e.g., spindle nut 30 described above in connection with FIG. 1) can be varied in connection with collection of different vibration samples. In such an example, the hub fastener (e.g., spindle nut) can be under-torqued, properly torqued, and/or over-torqued when securing a hub assembly to an axle, and vibration data can be collected for various different states of the hub fastener.

As another example, a condition of one or more bearings that facilitate rotation of a hub with respect to an axle can be varied. In a more particular example, vibration data can be collected from one or more axle assemblies with bearings in various states of wear (e.g., new, mildly worn, heavily worn, severely worn, damaged, etc.), which can correspond to a particular amount of use (e.g., based on a number of revolutions of the hub with respect to the axle, which can correlate to a distance traveled using the bearings). As another more particular example, vibration data can be collected from one or more axle assemblies with bearings with different levels of lubrication (e.g., inadequate lubrication and proper lubrication, contaminated lubricant, etc.), with a particular level of lubrication from a discrete set of predetermined levels, and/or a level within a range of levels.

As yet another example, a condition of one or more components of a brake system can be varied. In a more particular example, vibration data can be collected from one or more axle assemblies with a brake pad(s) in various states of wear (e.g., new, mildly worn, heavily worn, severely worn, damaged pad, etc.), which can correspond to a particular amount of use of the brake pad. As another more particular example, vibration data can be collected from one or more axle assemblies with a brake rotor in various states of wear (e.g., new, mild wear, heavy wear, damaged, light heat checking, severe heat checking, cracked, etc.), which can correspond to a particular amount of use of the brake rotor. As yet another more particular example, vibration data can be collected from one or more axle assemblies with a brake drum in various states of wear, which can correspond to a particular amount of use of the brake drum. As still another more particular example, vibration data can be collected from one or more axle assemblies with a brake caliper in various states of wear, which can correspond to a particular amount of use of the brake caliper. As a further more particular example, vibration data can be collected from one or more axle assemblies with a brake system having different maintenance conditions (e.g., inadequate or impaired caliper slide movement, inadvertent caliper activation such as when a parking brake is activated during vehicle motion, caliper overadjustment, failure to release after a breaking event, etc.), which can be caused by improper maintenance, insufficient preventive maintenance, and/or damage (e.g., from road debris, road conditions, weather conditions, etc.).

As still another example, a condition of one or more components of a suspension can be varied. In a more particular example, vibration data can be collected from one or more axle assemblies with a suspension component(s) in various states of wear (e.g., new, mildly worn, heavily worn, severely worn, etc.), which can correspond to a particular amount of use of the suspension.

As a further example, a condition of one or more components of a wheel assembly can be varied. In a more particular example, vibration data can be collected from one or more axle assemblies with a tire(s) in various states of inflation (e.g., underinflated, properly inflated, overinflated, deflated or flat, etc.). As another more particular example, vibration data can be collected from one or more axle assemblies with a tire(s) in various states of wear, which can correspond to a particular amount of tread wear if the tire. As yet another more particular example, vibration data can be collected from one or more axle assemblies with a tire(s) in various conditions (e.g., having an even wear pattern, having an uneven wear pattern such as a pattern consistent with cupping, a tire with a flat spot(s), a tire with a bulge(s), a tire with sidewall damage, a partially or fully blown out tire, etc.), which can be caused by improper maintenance, insufficient preventive maintenance, and/or damage (e.g., from road debris, weather conditions, etc.).

As another further example, a load on an axle assembly can be varied. In a more particular example, vibration data can be collected from one or more axle assemblies under various load conditions, which can correspond to an amount of mass of a vehicle supported by the axle assembly (e.g., corresponding to unloaded, one or more levels of partially loaded, fully loaded, overloaded, etc.). As a more particular example, vibration data can be collected for an axle assembly that is subject under particular load conditions (e.g., during turning maneuvers), and can be used to train machine learning model to predicted load within a relatively narrow range (e.g., within a range of approximately +/−5,000 lbs).

In some embodiments, a value representing a condition of a component(s) of a vehicle that can impact vibration and/or a condition of a vehicle can be represented using any suitable type of variable and/or label, such as a Boolean variable, a discrete variable, and/or a continuous variable. For example, a condition of a lug fastener and/or hub fastener used to secure components of an axle assembly can be represented using a Boolean variable (e.g., true if the fastener is properly torqued or false if improperly torqued); using discrete level from a set of levels (e.g., a first level corresponding to a fastener that is under-torqued, a second level corresponding to a fastener that is properly torqued, and a third level corresponding to a fastener that is over-torqued); using a discrete variable (e.g., representing a torque of a lug or hub fastener with respect to a proper amount of torque, for example, as a percentage or decimal value with 0% or 0.00 representing a fastener that is very loosely torques such as hand tightened, 100% or 1.00 representing a proper level of torque, and values larger than 100%/1.00 representing an amount of torque that exceeds the proper amount of torque); and/or using a continuous variable (e.g., representing an amount of torque, in foot-pound, pound-feet, newton-meters, etc.). As another example, a wear condition of a component (e.g., a bearing(s), a brake pad, a brake drum, a brake disk, etc.) can be represented using a Boolean variable (e.g., worn or unworn), a discrete level from a set of levels (e.g., new, mildly worn, heavily worn, severely worn, etc.), a discrete variable, and/or a continuous variable. As yet another example, whether a component is damaged and/or in a particular state of disrepair can be represented using a Boolean variable (e.g., true if undamaged or in a state of relatively good repair or false if damaged or in a state of significant disrepair, true if a level of brake fluid is adequate or false if the level of brake fluid is inadequate, etc.); a discrete variable; and/or a continuous variable.

In some embodiments, labeled vibration data 402 can include examples generated from recorded samples with one or more data augmentation techniques applied. For example, augmenting vibration data can include adding noise at one or more frequencies, reordering of portions of the sample (e.g., timeshifting), zeroing out a portion of the sample (e.g., all frequencies for a particular time bin of a spectrogram, all times for a particular frequency bin of a spectrogram), etc. Note that augmentation can be performed on raw vibration data prior to any pre-processing, and/or on pre-processed vibration data (e.g., a sample of raw vibration data can be augmented, and/or a spectrogram generated from a sample of vibration data can be augmented).

In some embodiments, untrained vehicle component monitoring system 404 can include one or more machine learning models having weights and/or hyperparameters that can be varied during a training process that is used to train the one or more machine learning models to predict a condition(s) of a vehicle component(s), and trained vehicle component monitoring system 414 can include one or more machine learning models trained to predict a condition(s) of a vehicle component(s), having weights and/or hyperparameters with values that were determined during a training process.

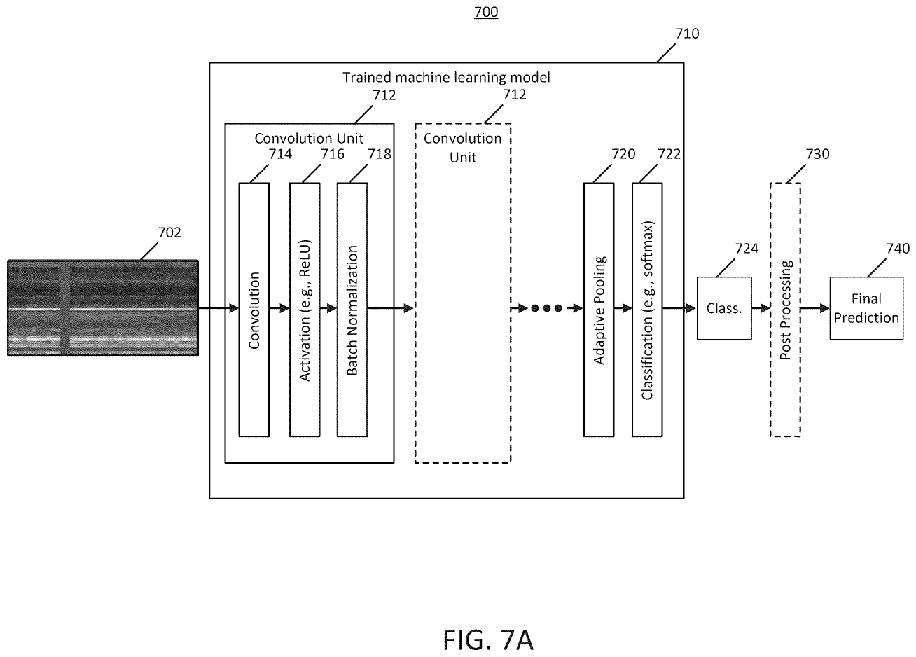

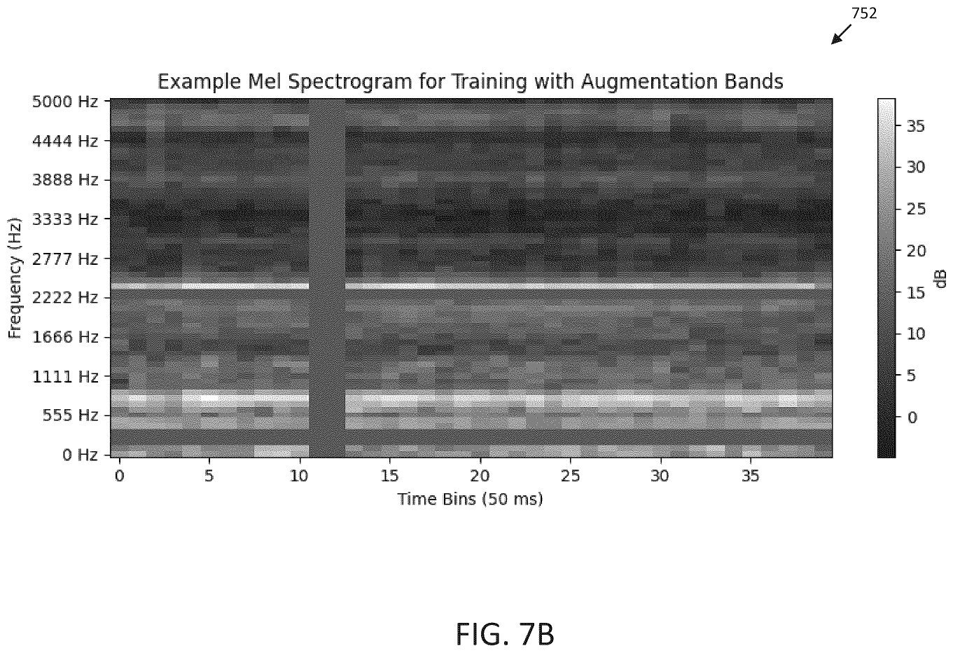

For example, as described below in connection with FIG. 7A, untrained vehicle component monitoring system 404 and/or trained vehicle component monitoring system 414 can include a classification model that takes a sample of vibration data collected from a first component of an axle assembly (e.g., axle 10), and/or a representation of the sample of vibration data, as input, and outputs a predicted classification(s) of a second component of the axle assembly (e.g., a rotating component such as hub assembly 20, a wheel assembly, a tire, etc.) among a set of classes. As another example, untrained vehicle component monitoring system 404 and/or trained vehicle component monitoring system 414 can include a regression model that takes a sample of vibration data (or representation thereof) collected from a first component of an axle assembly as input, and outputs a predicted state(s) of a second component of the axle assembly (e.g., within a range). In such examples, a sample of vibration data can be a predetermined amount of raw or processed vibration data from a stream of vibration data received from a vibration sensor, such as vibration sensor 102, and/or a vibration data source, such as vibration data source 202. A representation of a sample of vibration data can be a spectrogram, or other suitable representation, of the information encoded within a predetermined amount of vibration data. Note that although examples described herein are most often described in connection with predicting a state of a rotating component(s) of an axle assembly based on vibration data collected from a vibration sensor coupled to a non-rotating component of the axle assembly, a state of a non-rotating component of the axle assembly (e.g., a brake pad, a brake caliper, axle 10, etc.) or a component coupled to the axle assembly (e.g., a suspension component) can be predicted based on vibration data collected from a vibration sensor coupled to the same non-rotating component or another non-rotating component of the axle assembly. Additionally, a state of a rotating component(s) (e.g., a brake rotor, a hub, a hub flange, a wheel, etc.) and/or a non-rotating component(s) of the axle assembly (including components coupled to the axle assembly, such as suspension components) can be predicted based on vibration data collected from a vibration sensor coupled to the rotating component. In some embodiments, untrained vehicle component monitoring system 404 and/or trained vehicle component monitoring system 414 can include a machine learning model(s) configured to use vibration data collected from a component of an axle assembly (and/or a component coupled thereto) to predict a condition of one or more components of the axle assembly and/or components that are coupled to the axle assembly and likely to transmit vibrations to the axle assembly (e.g., whether there is a fastener that is not properly torqued, whether there is a component that is not properly lubricated, a wear condition of one or more components, whether a component is not properly inflated, whether a component is damaged or in a state of significant disrepair, etc.).

In some embodiments, untrained vehicle component monitoring system 404 can include a first machine learning model that is to be trained to predict a condition(s) of a particular vehicle component (and/or set of components) or a set of multiple different vehicle components (and/or sets of components) and one or more other machine learning models that are to be trained to predict a condition(s) of a different vehicle component(s) (and/or set(s) of components), and trained vehicle component monitoring system 414 can include multiple machine learning models each trained to predict a condition(s) of a different vehicle component or set of components, having weights and/or hyperparameters with values that were determined during a training process. For example, as described below in connection with FIG. 7A, untrained vehicle component monitoring system 404 and/or trained vehicle component monitoring system 414 can include: a first machine learning model (e.g., a classification model, a regression model, etc.) that takes a sample of vibration data collected from an axle assembly, and/or a representation of the sample of vibration data, as input, and outputs a predicted state(s) (e.g., a classification(s), a value within a range, a value of a continuous variable, etc.) of each of one or more particular components of the axle assembly; and one or more other machine learning models (e.g., a classification model(s), a regression model(s), etc.) that each takes a sample of vibration data collected from the axle assembly (e.g., the same sample provided as input to the first machine learning model, or a sample from the same period of time that was conditioned and/or pre-processed differently), and/or a representation of a sample of the vibration data (e.g., the same representation that was provided as input to the first machine learning model, or a representation that represents the same period of time but that was conditioned differently, pre-processed differently, and/or that represents a different portion of the data from the sample such as a different range of frequencies) as input, and outputs a predicted state(s) (e.g., a classification(s), a value within a range, a value of a continuous variable, etc.) for each of one or more other particular components of the axle assembly.

In some embodiments, untrained vehicle component monitoring system 404 and/or trained vehicle component monitoring system 414 can be configured to pre-process input vibration data to generate a suitable representation(s of the vibration data that can be input to the machine learning model(s). In such an example, pre-processing can include extracting a predetermined amount of vibration data from received vibration data (e.g., a stream of vibration data) as a sample to be analyzed, conditioning the vibration data (e.g., normalizing the data based on amplitudes within the sample, applying one or more filters, amplifying one or more portions of a received signal, etc.), and/or generating a spectrogram from the sample of vibration data to be analyzed. Additionally or alternatively, in some embodiments, untrained vehicle component monitoring system 404 and/or trained vehicle component monitoring system 414 can be configured to receive pre-processed vibration data (e.g., a sample of raw vibration data, a sample or stream of conditioned vibration data, a spectrogram generated from a sample of raw or condition vibration data, etc.) which can be used as input to the machine learning model(s) and/or which can be further processed to be suitable as input to the machine learning model(s).

In some embodiments, the machine learning model(s) included in untrained vehicle component monitoring system 404 can have any suitable architecture, topology, and/or hyperparameters, and can be trained using any suitable technique or combination of techniques. Additionally, in some embodiments, training of untrained vehicle component monitoring system 404 can include tuning of any suitable hyperparameters and/or weights associated with the machine learning model(s) included in untrained vehicle component monitoring system 404.

In some embodiments, during training, untrained vehicle component monitoring system 404 can generate one or more predicted states of a component(s) 406 corresponding to each labeled example in the set of labeled vibration data 402. For example, each prediction 406 can include a classification indicative of one particular class of a set of classes, such as a highest probability class (e.g., an identification of one particular class), that corresponds to the predicted current state of a vehicle component. As another example, each prediction 406 can include a set of confidence scores indicative of a probability that the current state of the vehicle component is an example of each class of a set of classes. In such an example, a linear activation function (e.g., a softmax activation function) can be used to map outputs of a classifier to a set of confidence scores. As yet another example, each prediction 406 can include a set of logits indicative of a probability that the current state of the component(s) is an example of each class of a set of classes. In such an example, the logits can be outputs of a non-linear activation layer, or based on outputs of a non-linear activation layer. As still another example, prediction 406 can include a value indicative of a predicted state(s) of the component(s) within a range of values indicative of a condition of the component (e.g., a wear level or value, a lubrication level or value, etc.).

In some embodiments, at 408, each prediction 406 output during training of untrained vehicle component monitoring system 404 can be used to calculate a value (e.g., a loss value) that can be used to evaluate performance of untrained vehicle component monitoring system 404, which can be used to tune weights of untrained vehicle component monitoring system 404 (and/or other values, such as hyperparameters) to improve performance of untrained vehicle component monitoring system 404 over time (e.g., over multiple batches, epochs, etc.). Additionally, a subset of labeled vibration data 402 can be reserved as test data (e.g., data not used in active training, and used to evaluate performance during training).

In some embodiments, trained vehicle component monitoring system 414 (e.g., resulting from the training of untrained vehicle component monitoring system 404) can be used to generate a predicted component state(s) 416 indicative of a predicted current state of a particular component(s) of the vehicle when a particular sample of unlabeled vibration data 412 collected from a vehicle (e.g., from an axle assembly of the vehicle) was generated. For example, unlabeled vibration data 412 can be generated by a vibration sensor (e.g., vibration sensor 102) associated with a portion of a vehicle (e.g., an axle assembly and associated components) in an unknown condition(s) (e.g., in an unknown state of wear, unknown state of lubrication, unknown state of repair, unknown state of inflation, supporting an unknown load, etc.) that is being monitored. In such an example, trained vehicle component monitoring system 414 can generate predicted component state(s) 416 indicative of a predicted current condition of a particular component(s) of the vehicle, which can be used to determine whether to alert an operator of the vehicle associated with the axle assembly to the current condition (e.g., to alert the operator to a flat tire on a trailer, to alert the operator to a loose spindle nut, etc.), allow a user (e.g., the operator of the vehicle, a fleet operator, etc.) to monitor a current condition of a component(s) of the vehicle monitored using trained vehicle component monitoring system 414, etc. In some embodiments, predicted component state(s) 416 can be a classification(s) and/or a value indicative of the predicted state (e.g., as described above in connection with predictions 406).

As described above, trained vehicle component monitoring system 414 can include multiple trained machine learning models, which can each be trained to predict states of different components and/or sets of components. In some embodiments, if a reliability of predictions of states of some components varies based on one or more other factors (e.g.,), trained vehicle component monitoring system 414 can use additional data indicative of environmental conditions and/or events (e.g., current speed, average speed over a predetermined period of time, acceleration data, temperature, humidity, a brake signal, etc.) from one or more other data sources (e.g., a telematics system associated with the vehicle or a portion of the vehicle, an accelerometer mounted to a different portion of the vehicle such as a portion of the trailer body, a wire configured to operate brake lights of the vehicle, a sensor associated with a brake line, a temperature sensor, an electronic control unit (ECU) associated with the vehicle or a portion of the vehicle, etc.) to determine which machine learning model(s) are likely to provide reliable predictions and/or which are likely to provide unreliable predictions (e.g., inaccurate predictions with high confidence, relatively accurate but low confidence predictions, etc.), which can potentially increase the accuracy of final predictions. For example, a sample of unlabeled vibration data 412 collected from a vehicle that is idling at a stop sign may cause a predicted state of a rotating component of a hub assembly to be unreliable that is generated using the sample to be unreliable, as the rotating component is not rotating relative to the axle assembly while idling. In a more particular example, trained vehicle component monitoring system 414 can use an indication of current speed (e.g., from a GPS sensor, from an ECU of a tractor of the vehicle, etc.) to determine whether to provide vibration data (or a representation(s) thereof) to a machine learning model(s) that are unreliable when the vehicle speed is below a threshold speed. In such an example, if the current vehicle speed was below the threshold speed when the vibration data was collected, trained vehicle component monitoring system 414 can inhibit the vibration data from being used by the model(s) that is unreliable. In another more particular example, trained vehicle component monitoring system 414 can use an indication of current speed (e.g., from a GPS sensor, from an ECU of a tractor of the vehicle, etc.) to determine whether to rely on a prediction from a machine learning model(s) that is unreliable when the vehicle speed is below a threshold speed. In such an example, if the current vehicle speed was below the threshold speed when the vibration data was collected, trained vehicle component monitoring system 414 can down-weight and/or disregard an output from the unreliable model(s) corresponding to inputs collected when vehicle speed was below the threshold.

In some embodiments, predicted component state(s) 416 can be based on multiple outputs of trained vehicle component monitoring system 414, which can potentially increase the accuracy of final predictions. For example, as shown in FIG. 4, further processing can be performed, at 418, to generate predicted component state(s) 416 based on multiple predictions generated by trained vehicle component monitoring system 414, such as a series of outputs corresponding to a series of vibration data samples generated over time. More examples of additional processing techniques that can be used to generate a predicted vehicle component state are described below in connection with FIG. 5.

FIG. 5 shows an example of a process 500 for monitoring a rotating component of a vehicle based on vibration of a component coupled in accordance with some embodiments of the disclosed subject matter.

At 502, process 500 can receive vibration data recorded by a vibration sensor mounted to a vehicle component. In some embodiments, process 500 can receive vibration data from any suitable source, using any suitable technique or combination of techniques. For example, process 500 can receive vibration data directly from a vibration sensing component of a vibration sensor as vibrations are detected (e.g., as an analog signal present on a wire(s) connected to the vibration sensing component). As another example, process 500 can receive vibration data from signal conditioning components of the vibration sensor as vibrations are detected (e.g., as an analog or digital signal present on a wire(s) connected to the signal conditioning components). As yet another example, process 500 can receive a stream of vibration data from a processor(s) of the vibration sensor (e.g., a microcontroller of a vibration sensor) via a communication link(s) with the processor (e.g., as a digital signal transmitted via the communication link(s)) in real-time as the processor receives a signal from a vibration sensing component and/or signal conditioning components. As still another example, process 500 can receive a file (e.g., an audio file) that includes vibration data from a vibration data source (e.g., vibration data source 202) that stored the file in memory.

In some embodiments, generation of vibration data using a vibration sensor(s) can be relatively continuous, or can be periodic (e.g., at regular and/or irregular intervals). For example, a vibration sensor (e.g., vibration sensor 102) can be configured to generate vibration data based on vibrations of a vehicle component(s) substantially continuously. In such an example, the vibration sensor can be a passive sensor that is configured to generate and output electrical signals in response to vibrations regardless of whether power is being provided, or can be an active sensor (e.g., including a passive sensor equipped with a pre-amplifier) that is configured to generate and output electrical signals in response to vibrations when receiving power. As another example, a vibration sensor (e.g., vibration sensor 102) can be configured to generate vibration data periodically at regular intervals. In such an example, the vibration sensor can be operated at any suitable interval, which can vary depending on the condition(s) that is being monitored, and/or how quickly the condition may change. As yet another example, a vibration sensor (e.g., vibration sensor 102) can be configured to generate vibration data in response to occurrence of an event. In such an example, the vibration sensor can be operated in response to an event that is associated with more accurate results (e.g., if certain predictions are more accurate when the vehicle is moving within a predetermined range of speeds, if certain predictions are more accurate after the vehicle has used the brakes to slow down or stop one or more times, etc.).

In some embodiments, recording of generated vibration data can be relatively continuous, or can be periodic (e.g., at regular and/or irregular intervals). For example, a device configured to record vibration data output from a vibration sensor (e.g., vibration sensor 102) can be configured to record all data output by the vibration sensor in memory (e.g., a buffer, volatile memory, non-volatile memory). As another example, a device configured to record vibration data output from a vibration sensor (e.g., vibration sensor 102) can be configured to record vibration data periodically at regular intervals. In such an example, vibration data that is output from the vibration sensor can be recorded during some periods of time, and can be disregarded during other periods of time. As yet another example, a device configured to record vibration data output from a vibration sensor (e.g., vibration sensor 102) can be configured to record vibration data in response to occurrence of an event.

In some embodiments, analysis of vibration data can be relatively continuous, or can be periodic (e.g., at regular and/or irregular intervals). For example, process 500 can pre-process vibration data (e.g., at 504) and analyze the vibration data (e.g., at 506 to 510) as vibration data is received at 502. As another example, process 500 can pre-process vibration data (e.g., at 504) and analyze the vibration data (e.g., at 506 to 510) periodically at regular intervals. As yet another example, process 500 can pre-process vibration data (e.g., at 504) and analyze the vibration data (e.g., at 506 to 510) in response to occurrence of an event(s).

At 504, process 500 can pre-process a predetermined portion of the received vibration data for input to a trained machine learning model for predicting a state of a vehicle component(s) based on the vibration data. In some embodiments, pre-processing at 504 can include any suitable technique or combination of techniques to transform vibration data received at 502 into a format that is suitable for input to a machine learning model(s) trained to predict a state of a vehicle component(s) based on vibrations collected from the vehicle component and/or via a vehicle component(s) connected thereto. For example, process 500 can use techniques described below in connection with FIG. 6 to pre-process vibration data. As another example, process 500 can generate a representation of changes in frequency components of vibration data encoded as an audio signal over time. In such an example, the representation can be generated with particular dimensions, such as a particular length (e.g., in time bins) and a particular height (e.g., in frequency bins), that correspond to the dimensions of training data used to train the machine learning model(s).

At 506, process 500 can provide the pre-processed vibration data as input to a machine learning model trained to predict a state of a vehicle component(s) based on vibrations received at 502. For example, process 500 can provide the pre-processed vibration data to a machine learning model described above in connection with trained vehicle component monitoring system condition monitoring system 414 of FIG. 4.

At 508, process 500 can receive, from the trained machine learning model, an output indicative of a predicted state of one or more vehicle components (e.g., a particular component, a particular set of components, multiple different types of particular components, multiple different sets of components, etc.) when the predetermined portion of the vibration data was recorded. In some embodiments, output indicative of the predicted state of the vehicle component(s) can include a classification(s) and/or a value indicative of a current predicted state of the component(s) (e.g., as described above in connection with predictions 406 and 416 of FIG. 4).

In some embodiments, if multiple samples of vibration data are created from a single longer sample and analyzed concurrently (e.g., as described below in connection with process 600 of FIG. 6), each prediction outputted concurrently can be treated as a separate output indicative of the predicted state of the component(s), or the output can be based on a consensus of the multiple predictions (e.g., the output can be a class that was predicted most often among the multiple predictions generated concurrently, can be a class that was predicted most often with at least a threshold confidence among the multiple predictions generated concurrently, can based on an average confidence of each class, etc.). For example, if each sample provided as input to the trained machine learning model is based on a two second audio clip of vibration data, and a received sample is about 16 seconds long, the longer sample can be used to generate eight inputs for the machine learning model(s) (e.g., eight spectrograms), which can be used to generate eight predictions (e.g., substantially in parallel) for each vehicle component(s) for which the machine learning model(s) is trained to predict a condition. In such an example, the output received at 508 can include all eight of the predictions (e.g., for each vehicle component), or can be fewer predictions (e.g., a single prediction, or multiple predictions) based on the eight predictions.

At 510, process 500 can generate a final prediction of the current state of the vehicle component(s) based on one or more outputs of the trained machine learning model. In some embodiments, process 500 can use any suitable technique or combination of techniques to generate a final prediction based on one or more outputs of the trained machine learning model, which can be configured to improve an accuracy of the prediction, and/or decrease volatility of predictions over relatively short periods of time. For example, process 500 can determine whether a particular prediction received from the trained machine learning model is reliable (e.g., based on a confidence value associated with the prediction, based on a comparison of a particular predicted state to an average predicted state over a predetermined period of time). As another example, process 500 can determine the final prediction based on a set of relatively recent predictions (e.g., based on which class was predicted the greatest number of times, based on an average of values indicative of the current predicted state of the vehicle component(s)). In some embodiments, process 500 can omit 510 (e.g., if a single prediction of the trained machine learning model is always to be used).

In some embodiments, if a classification(s) is output from the trained machine learning model(s) (e.g., if one or more of the trained machine learning models from which an output is received is a classification model), process 500 can record a predetermined number of predictions generated over a predetermined period of time (e.g., corresponding to about ten seconds, twenty seconds, thirty seconds, a minute, etc.), and can evaluate the set of predictions to determine the final prediction. For example, process 500 can determine which classification was predicted with the highest probability most often during the predetermined period of time, and can select that class as the final prediction. In a more particular example, if all predictions in the set of predictions are the same (e.g., sufficiently greased or insufficiently greased was always the highest probability class output from a machine learning model trained to output likelihoods that the vibration data in the input was an example of each of two classes corresponding to an acceptable condition and an unacceptable condition, such as properly torqued and improperly torqued, properly lubricated and inadequately lubricated, properly inflated and improperly inflated, unworn and worn, etc.), process 500 can select that class as the final prediction. As another more particular example, if all predictions in the set of predictions are a particular class, process 500 can select that class as the final prediction (e.g., even if the classification values of all of the predictions are relatively low confidence).

As another example, process 500 can determine whether a particular class was predicted with the highest probability at least a predetermined number of times within the predetermined period of time (e.g., at least a threshold number of times), or at least a predetermined proportion of the predetermined period of time (e.g., the portion of the predetermined period of time predicted as the particular class compared to the total length of the predetermined period of time). In such an example, if no class was predicted a sufficient number of times or proportion of the predetermined period of time, the final prediction can be a most recent final prediction that was based on a class that was predicted a sufficient number of times or proportion within the predetermined period of time.

In some embodiments, predicted classifications output by the trained machine learning model can be disregarded and/or given less weight if the confidence of the prediction is below a threshold. For example, for a classification model that outputs a value indicative of a likelihood of membership in each class, process 500 can disregard the prediction if the higher probability class is less than a threshold (e.g., about 55%, 60%, 65%, 70%, etc.).

In some embodiments, if a predicted state is output from the trained machine learning model as a value (e.g., if the trained machine learning model is a regression model), process 500 can record a predetermined number of predictions generated over a predetermined period of time (e.g., corresponding to about ten seconds, twenty seconds, thirty seconds, a minute, etc.), and can evaluate the set of predictions to determine the final prediction. For example, process 500 can calculate an average (e.g., a simple average or a weighted average) of the predictions over the predetermined period of time.

In some embodiments, a predicted state output by the trained machine learning model can be disregarded and/or given less weight if the value of the predicted state is an outlier (e.g., is more than a predetermined number of standard deviates from the average). For example, for a regression model that outputs a value indicative of a predicted state, process 500 can disregard a prediction if the value is more than a standard deviation from an average (or more, such as 1.5 standard deviations, two standard deviations, etc.).

In some embodiments, one or more additional inputs can be used to determine whether a final prediction is reliable, and/or to adjust a value of the final prediction. For example, process 500 can determine whether a current vehicle speed or average vehicle speed is consistent with the final prediction (e.g., a rapid change in a state of a rotating component may be relatively unlikely if the vehicle is stopped, vibration associated with bearings and/or braking activity may have different characteristics at different speeds, etc.), and/or process 500 can adjust the final prediction based on a vehicle speed value. As another example, process 500 can determine that an output of a trained machine learning model that predicts a state of a particular component(s) is to be disregarded if another data source indicates that the vehicle speed is outside of a predetermined range (e.g., a machine learning model can be trained based on sample data within a predetermined range of speeds such as 40-60 mph for some rotating components, and input to, or outputs from, the model can be inhibited outside of the range, and/or a reliability of an output based on whether the current speed is within the range).

In some embodiments, a user can be permitted to provide input that causes a final prediction to be adjusted (e.g., scaled). For example, a user can provide input indicating that a component is in a particular condition (e.g., when a new tire is installed, when a new brake component is installed, when a component has been recently serviced, etc.), and the final output can be scaled based on the prediction output by the trained model (e.g., if the model predicts that a brake pad is at 30% worn when the user indicates that the brake pad is new, process 500 can scale predictions of the model using 30% worn as a baseline).

At 512, process 500 can determine whether to provide the predicted state of the vehicle component(s) to a user. In some embodiments, process 500 can use any suitable technique or combination of techniques to determine whether to provide the predicted state of one or more vehicle components to a user. For example, in some embodiments, process 500 can determine that the predicted state of a component is to be provided to a user if the predicted state is a state that is likely to be dangerous and/or is likely to cause damage or premature wear to the component, and/or another component of the vehicle (e.g., if a hub fastener, such as a spindle nut is predicted to be loose). As another example, process 500 can determine that the predicted state of the component is to be provided to a user if the predicted state has changed relatively quickly (e.g., if a predicted state of a tire has changed from properly inflated to underinflated relatively quickly). As yet another example, process 500 can determine that the predicted state of the component is to be provided to a user if a predetermined event has occurred relatively recently. In a more particular example, if a vehicle is being operated after a relatively long period of time when the vehicle was stationary (e.g., days, weeks, or longer), process 500 can determine that the predicted state of the component is to be provided to a user, as the state of the component may have changed while the vehicle was stationary. As a yet more particular example, if a loaded trailer has been stationary for days, weeks, or longer, it can allow a slowly leaking tire that was properly inflated when the trailer was parked to become underinflated when the trailer is moved again, can lead to flat spots on a tire, can allow a slow leak of a fluid such as bearing lubricant or brake fluid to lead to a dangerous condition, etc.). As still another example, process 500 can determine that the predicted state of the component(s) is to be provided to a user if the predicted state satisfies a condition (e.g., a condition set by a user).

If process 500 determines that the predicted state is not to be presented to the user(s) (“NO” at 514), process 500 can return to 502. For example, process 500 can continue to monitor a condition(s) of the vehicle component(s) until a predetermined event occurs that causes the predicted state to be provided to the user.

Otherwise, if process 500 determines that the predicted state is to be presented to the user(s) (“YES” at 514), process 500 can move to 516.

At 516, process 500 can cause a predicted state of the component(s) to be presented to one or more users. In some embodiments, process 500 can use any suitable technique or combination of techniques to cause the predicted state of the component(s) to be presented to one or more users. For example, process 500 can use techniques described above in connection with FIG. 1 to cause the predicted state of the component(s) to be presented by one or more user interface devices (e.g., an output of a local computing device such as local computing device 104, a local output device such as local output device 108).

In some embodiments, process 500 can omit 512 to 516. For example, if predictions output by a trained machine learning model are provided to a computing device associated with the user (e.g., a local computing device in communication with a device executing at least a portion of process 500, a remote computing device in communication with a device executing at least a portion of process 500), and the computing device is configured to present predictions about a condition of the vehicle component(s) to a user (e.g., to provide access to predictions, to generate alerts based on predictions, etc.).

FIG. 6 shows an example of a process 600 for pre-processing vibration data in accordance with some embodiments of the disclosed subject matter. At 602, process 600 can receive a sample of a signal recorded by a vibration sensor mounted to a vehicle component (e.g., a non-rotating component of an axle assembly, a rotating component of an axle assembly, etc.) during a particular period of time. In some embodiments, process 600 can receive the sample in any suitable format, and can be received from any suitable source. For example, the sample can be in an audio format in which detected vibrations of a vehicle component are encoded as an amplitude signal that varies over time.

At 604, process 600 can adjust a length of the received sample to a predetermined length if a period of time represented by the sample does not correspond to the predetermined length of time. In some embodiments, process 600 can determine whether a length of the sample is equal to a predetermined length (e.g., in time, data points, etc.). For example, if a machine learning model trained to predict a state of a vehicle component(s) based on vehicle component vibrations was trained using samples that represented a predetermined length of time (e.g., one second, two seconds, etc.), process 600 can determine whether the received sample represents the same length of time.

In some embodiments, if the length of the sample does not correspond to the predetermined length of time, process 600 can adjust a length of the sample. For example, if the sample is longer than the predetermined period of time, process 600 can delete one or more portions of the sample (e.g., from the beginning, from the end, from the beginning and end, etc.) to shorten the sample to the predetermined length. As another example, if the sample is shorter than the predetermined period of time, process 600 can add additional vibration data to the sample (e.g., at the beginning, at the end, at the beginning and end, etc.) to lengthen the sample to the predetermined length. In such an example, process 600 can pad the sample with zeros (e.g., corresponding to silence).

Additionally or alternatively, in some embodiments, if the received sample is more than twice the predetermined length, process 600 can generate multiple samples that are each the predetermined length from the longer sample. For example, a trained vehicle component monitoring system can be configured to analyze batches of samples in parallel, and process 600 can divide a longer sample into a number of samples that are suitable for parallel analysis by the trained vehicle component monitoring system.

At 606, process 600 can adjust a sampling frequency of the received sample to a predetermined sampling frequency if the sample was recorded and/or received at another sampling frequency. In some embodiments, process 600 can determine whether a sampling rate of the sample is equal to a predetermined sampling rate (e.g., in kilohertz (kHz)). For example, if a machine learning model trained to predict a state of a vehicle component based on vehicle component vibrations was trained using vibration data samples encoded at a predetermined sampling rate 10 kHz, 12 kHz, 24 kHz, 44.1 kHz, 48 kHz, 92 kHz, 96 kHz, etc.), process 600 can determine whether the received sample is encoded at the predetermined sampling rate. As another example, if a machine learning model trained to predict a state of a vehicle component based on based on vehicle component vibrations was trained using a representation of components of the vibration data in the frequency domain (e.g., a frequency domain representation, such as a spectrogram) generated from data encoded at a predetermined sampling rate (e.g., 10 kHz, 12 kHz, 24 kHz, 44.1 kHz, 48 kHz, 92 kHz, 96 kHz, etc.), process 600 can determine whether the received sample is encoded at the predetermined sampling rate. As yet another example, if a computing device that is to be used to generate a frequency domain representation of the vibration data has limited compute resources, reducing the sampling rate can reduce the amount of compute resources needed to, and/or used to, generate a frequency domain representation from time domain vibration data.

In some embodiments, if the sample rate of the sample does not correspond to the predetermined sample rate, process 600 can adjust the sample rate of the sample. For example, if the sample vibration data is encoded at a higher sample rate, process 600 can reduce the sample rate (e.g., by subsampling or downsampling the sample) to the predetermined sample rate. As another example, if the sample vibration data is encoded at a lower sample rate than the predetermined sample rate, process 600 can increase the sample rate (e.g., using conventional audio upsampling techniques and/or audio upsampling techniques that incorporate machine-learning).

In some embodiments, process 600 can omit 604 and/or 606. For example, if the vibration data sample is the predetermined length and/or is encoded at the predetermined sample rate. Additionally, process 600 can perform one or more other operations to match characteristics of the vibration data sample to characteristics of training data, such as a bit depth used to encode the signals.

At 608, process 600 can generate a frequency domain representation of frequency components of the sample over at least a portion of the predetermined length of time. In some embodiments, process 600 can use any suitable technique or combination of techniques to generate a frequency domain representation of the sample, which can be in any suitable format. For example, process 600 can use one or more time-frequency transform techniques to generate a spectrogram that represents the amplitude of different frequencies in the signal over time. In a more particular example, process 600 can use fast Fourier transform (FFT) techniques, Stockwell transform (S transform) techniques, and/or any other suitable technique to determine the frequency components present in the vibration data sample at different points in time.

In some embodiments, process 600 can generate a spectrogram that is formatted as an image for which one axis (e.g., the x-axis) represents time, the other axis (e.g., the y-axis) represents frequency, and a value of a pixel (e.g., a brightness value, chrominance and luminance values, RGB values, etc.) represents the amplitude of a specific frequency or range of frequencies in the vibration data sample at a particular time (or over a particular period of time). In some embodiments, such a spectrogram image can be provided as input to a machine learning model configured to analyze image data. In some embodiments, the time bins and/or frequency bins can be uniformly sized (e.g., the frequency range in the vibration data can be evenly divided into equal sized frequency bins). Alternatively, in some embodiments, the range of frequencies in different frequency bins can be different (e.g., based on the mel scale).

FIG. 7A shows an example of a high level architecture 700 of a machine learning model that can be used to implement mechanisms for monitoring a rotating component of a vehicle based on vibration of a component coupled in accordance with some embodiments of the disclosed subject matter. As shown in FIG. 7A, a spectrogram 702 representing a sample of vibration data from a vehicle component (e.g., as described above in connection with FIG. 6) can be provided as input to a trained machine learning model 710 for predicting a state of the vehicle component and/or one or more other vehicles components to which the vehicle component is coupled. In some embodiments, spectrogram 702 can be provided to trained machine learning model 710 using two input channels of trained machine learning model 710. For example, the two input channels of trained machine learning model 710 can be configured to receive spectrogram data generated from different channels (e.g., a left channel and a right channel of a stereo audio signal). In a more particular example, the two channels can represent the same vibration data (e.g., if spectrogram 702 is generated from a mono channel audio signal, the information in the mono channel audio signal can be cloned to provide data for a second channel). In such an example, the data provided via the first channel and the data provided via the second channel can be identical. As another more particular example, the two channels can represent vibration data collected using multiple vibration sensors mounted at different mounting locations (e.g., with reference to FIG. 1, a vibration sensor 102 mounted at one end of axle 10 and vibration sensor 102′ mounted at mounted at opposite end of axle 10). Alternatively, in some embodiments, spectrogram 702 can be provided to trained machine learning model 710 using one input channel (e.g., if single channel data is used during training), or more than two channels (e.g., if data collected concurrently from more than two vibration sensors mounted to detect vibrations of vehicle components are used during training). In some embodiments, spectrogram 702 can be provided to trained machine learning model 710 as a four-dimensional tensor with dimensions B×C×H×W, where B represents the number of samples processed in a batch (e.g., a number of individual audio signals that are being processed, for example, a batch number of 8 can indicate that trained machine learning model 710 processes eight samples in parallel, which can improve processing efficiency of trained machine learning model 710; if trained machine learning model 710 is configured to process a single sample, the input can be a three-dimensional tensor C×H×W), C represents the number of input channels (e.g., corresponding to left and right audio signals of a stereo audio signal, corresponding to two copies of a mono stereo signal, etc. ; if trained machine learning model 710 is configured to process mono channel data, the input can be a three-dimensional tensor B×H×W, or a two-dimensional tensor H×W if trained on single-channel single-batch data), H represents the height of the spectrogram, and W represents the width of the spectrogram.

In some embodiments, trained machine learning model 710 can include one or more convolution units 712, which can receive an input (e.g., a first convolution unit can receive spectrogram 702 as input, a subsequent convolution unit, if present, can receive an output of the previous convolution unit as input, etc.). In some embodiments, the number of convolution units 712 can be a hyperparameter that can be tuned.

In some embodiments, each convolution unit 712 can include a convolution layer 714, an activation layer 716 (e.g., a rectified linear unit (ReLU) activation layer), and a batch normalization layer 718. In some embodiments, convolution layer 714, activation layer 716, and batch normalization layer 718 can be configured to generate any suitable number of output channels (e.g., eight output channels). In some embodiments, characteristics of convolution layer 714, activation layer 716, and batch normalization layer 718 (e.g., a size of a kernel, a stride, a number of output channels, etc.) can be a hyperparameter that can be tuned.

In some embodiments, a pooling layer (e.g., an adaptive pooling layer 720) can receive, as input, outputs of a final convolution unit 712, and an output of adaptive pooling layer 720 can be provided as input to a classification layer 722.

In some embodiments, classification layer 722 can be a linear classifier (e.g., a softmax layer) configured to output a classification 724 indicative of a predicted state of one or more vehicle components coupled to the vibration sensor (e.g., a component to which the vibration sensor is mounted or a component(s) coupled, directly or indirectly, to the coupled to the component to which the vibration sensor is mounted) from which the sample of vibration data was collected. In some embodiments, classification 724 can include an identifier of the class(es) predicted to correspond to the state(s) of the component(s), which can each be associated with a particular condition of the component(s), and/or can include an identifier(s) of the predicted state. In some embodiments, classification layer 722 can be configured to output classification values (e.g., probabilities, logits) for any suitable number of classes. For example, classification layer 722 can be configured to output classification values for two classes (e.g., whether a component is worn or unworn, properly torqued or improperly torqued, properly inflated or improperly inflated, etc.). As another example, classification layer 722 can be configured to output classification more than two classes (e.g., whether a component is predicted to be over-torqued, properly torqued, or under-torqued; whether a tire is underinflated, properly inflated, or overinflated; whether a brake pad is new, mildly worn, heavily worn, severely worn; etc.).

In some embodiments, classification 724 can be used to generate a final prediction 740 of a current state of the vehicle component(s), which can be presented to a user and/or used to alert a user to a condition of the component(s). As described above in connection with 418 of FIG. 4, classification 724 can be further processed at 730 to generate final prediction 740, where further processing 730 can be configured to improve an accuracy of final prediction 740 and/or reduce volatility of final prediction 740.

As described above in connection with FIG. 4, mechanisms described herein can be implemented using a regression model (e.g., in addition to, or in lieu of, a classification model, an example of which is shown in FIG. 7A). In such embodiments, an architecture of a regression model can be similar to trained machine learning model 710, with classification layer 722 of FIG. 7A replaced by an output layer that is implemented using a linear activation function configured to output a continuous value (e.g., within a predetermined range) that represents the predicted state of the vehicle component(s).

FIG. 7B shows an example spectrogram 752 that can be used to train a machine learning model in accordance with some embodiments of the disclosed subject matter, which is normalized, includes augmentation bands along one frequency bin and two time bins, includes axis labels, and a legend.

### Further Examples Having a Variety of Features

1. A system for monitoring a state of a rotating vehicle component, the system comprising: a vibration sensor configured to be mounted to a first vehicle component which is coupled to a second vehicle component; and one or more hardware processors configured to: provide a frequency domain representation of a sample of vibration data recorded using the vibration sensor to a trained machine learning model that is trained to predict a state of the second vehicle component based on vibrations of the first vehicle component; receive, from the trained machine learning model, an output indicative of a predicted state of the second vehicle component at the time that the sample of vibration data was recorded; and transmit a signal to an external device that is indicative of a current predicted state of the second vehicle component.
2. The system of clause 1, wherein the one or more hardware processors are further configured to: receive, from a vibration data source, the sample of vibration data; normalize the sample of vibration data; and convert the sample of vibration data to the frequency domain representation.
3. The system of clause 2, wherein the vibration data source comprises the vibration sensor.
4. The system of any one of clauses 1 to 3, wherein the frequency domain representation comprises a spectrogram.
5. The system of any one of clauses 1 to 4, wherein the vibration sensor comprises a piezoelectric microphone.
6. The system of any one of clauses 1 to 5, wherein the trained machine learning model is a classification model that is trained to predict a likelihood that the second vehicle component coupled to the first vehicle component from which the vibration data was recorded is an example of each of a plurality of classes.
7. The system of clause 6, wherein the first vehicle component and the second vehicle component are rotatably coupled portions of an axle assembly of a vehicle, and wherein the trained machine learning model is trained to predict whether the first vehicle component and second vehicle component are securely coupled.
8. The system of clause 7, wherein the first vehicle component is a non-rotating portion of a beam axle of the axle assembly, the second vehicle component is a rotating portion of a hub assembly of the axle assembly, and the plurality of classes includes a properly torqued spindle nut class indicative of whether a spindle nut used to secure the hub assembly to the non-rotating portion of the beam axle is properly torqued, indicating that the first vehicle component and second vehicle component are securely coupled.
9. The system of any one of clauses 1 to 8, wherein the one or more hardware processors are further configured to: receive, from the trained machine learning model, a plurality of outputs indicative of a predicted state of the second vehicle component at different times; and determine a final prediction based on the plurality of outputs; determine that a user is to be presented with an alert based on the final prediction; and transmit the signal to the external device, thereby causing an alert to be presented to the user by the external device.
10. The system of any one of clauses 1 to 9, wherein the external device is a mobile computing device associated with the user.
11. The system of any one of clauses 1 to 9, wherein the first vehicle component and the second vehicle component are portions of an axle assembly of a trailer that is configured to be coupled to a tractor via a fifth wheel.
12. The system of clause 11, wherein the external device is an embedded computing device of the tractor.
13. The system of clause 11, wherein the external device is a dashboard of the tractor.
14. The system of clause 11, wherein the external device is a telematics system of the trailer.
15. The system of any one of clauses 1 to 9, wherein the external device is a remote computing device associated with a cloud computing service.
16. The system of any one of clauses 1 to 15, wherein the one or more hardware processors are further configured to: receive, from the vibration sensor, a stream of audio data; record a portion of the stream of audio data as an audio file; divide the audio file into a plurality of vibration data samples, including the sample of vibration data; normalize each of the plurality of the vibration data samples based on audio levels within the respective sample; convert the plurality of vibration data samples into a plurality of mel spectrograms; provide the plurality of mel spectrograms to the trained machine learning model as a batch; receive a plurality of outputs, each corresponding to a respective vibration data sample of the plurality of vibration data samples, and each indicative of the predicted state of the second vehicle component at the time that the respective vibration data sample was recorded; and determine a final prediction based on the plurality of outputs.
17. A method for monitoring a state of a rotating vehicle component, the method comprising: providing a frequency domain representation of a sample of vibration data recorded using a vibration sensor mounted to a first vehicle component which is coupled to a second vehicle component to a trained machine learning model that is trained to predict a state of the second vehicle component based on vibrations of the first vehicle component; receiving, from the trained machine learning model, an output indicative of a predicted state of the second vehicle component at a time that the sample of vibration data was recorded; and transmitting a signal to an external device that is indicative of a current predicted state of the second vehicle component.
18. The method of clause 17, further comprising: receiving, from a vibration data source, the sample of vibration data; normalizing the sample of vibration data; and converting the sample of vibration data to the frequency domain representation.
19. The method of clause 18, wherein the vibration data source comprises the vibration sensor.
20. The method of any one of clauses 17 to 19, wherein the frequency domain representation comprises a spectrogram.
21. The method of any one of clauses 17 to 20, wherein the vibration sensor comprises a piezoelectric microphone.
22. The method of any one of clauses 17 to 21, wherein the trained machine learning model is a classification model that is trained to predict a likelihood that the second vehicle component coupled to the first vehicle component from which the vibration data was recorded is an example of each of a plurality of classes.
23. The method of clause 22, wherein the first vehicle component and the second vehicle component are rotatably coupled portions of an axle assembly of a vehicle, and wherein the trained machine learning model is trained to predict whether the first vehicle component and second vehicle component are securely coupled.
24. The method of clause 23, wherein the first vehicle component is a non-rotating portion of a beam axle of the axle assembly, the second vehicle component is a rotating portion of a hub assembly of the axle assembly, and the plurality of classes includes a properly torqued spindle nut class indicative of whether a spindle nut used to secure the hub assembly to the non-rotating portion of the beam axle is properly torqued, indicating that the first vehicle component and second vehicle component are securely coupled.
25. The method of any one of clauses 17 to 24, further comprising: receiving, from the trained machine learning model, a plurality of outputs indicative of a predicted state of the second vehicle component at different times; and determining a final prediction based on the plurality of outputs; determining that a user is to be presented with an alert based on the final prediction; and transmitting the signal to the external device, thereby causing an alert to be presented to the user by the external device.
26. The method of any one of clauses 17 to 25, wherein the external device is a mobile computing device associated with the user.
27. The method of any one of clauses 17 to 25, wherein the first vehicle component and the second vehicle component are portions of an axle assembly of a trailer that is configured to be coupled to a tractor via a fifth wheel.
28. The method of clause 27, wherein the external device is an embedded computing device of the tractor.
29. The method of clause 27, wherein the external device is a dashboard of the tractor.
30. The method of clause 27, wherein the external device is a telematics system of the trailer.
31. The method of any one of clauses 17 to 25, wherein the external device is a remote computing device associated with a cloud computing service.
32. The method of any one of clauses 17 to 31, further comprising: receiving, from the vibration sensor, a stream of audio data; recording a portion of the stream of audio data as an audio file; dividing the audio file into a plurality of vibration data samples, including the sample of vibration data; normalizing each of the plurality of the vibration data samples based on audio levels within the respective sample; converting the plurality of vibration data samples into a plurality of mel spectrograms; providing the plurality of mel spectrograms to the trained machine learning model as a batch; receiving a plurality of outputs, each corresponding to a respective vibration data sample of the plurality of vibration data samples, and each indicative of the predicted state of the second vehicle component at the time that the respective vibration data sample was recorded; and determining a final prediction based on the plurality of outputs.
33. The method of clause 32, wherein the audio file corresponds to about 16 seconds of audio data recorded at a sample rate of 96 kHz, and wherein each of the vibration data samples corresponds to about two seconds of the audio file, and is downsampled to a sample rate of 10 kHz.
34. The method of any one of clauses 17 to 21 or 25 to 33, wherein the trained machine learning model is a regression model that is trained to predict a current state of the second vehicle component coupled to the first vehicle component from which the vibration data was recorded from a range of states.
35. The method of any one of clauses 17 to 34, wherein the second vehicle component comprises one of the following vehicle components: a lug nut; a set of lug nuts; a lug bolt; a set of lug bolts; a spindle nut; a set of spindle nuts; a bearing of a hub assembly; a set of bearings of a hub assembly; a brake pad; a brake drum; a brake rotor; a brake caliper; a tire; or a set of tires.
36. The method of clause 35, wherein the predicted state is one of the following: whether the lug nut is not properly torqued; whether at least one lug nut of the set of lug nuts is not properly torqued; whether the lug bolt is not properly torqued; whether at least one lug bolt of the set of lug bolts is not properly torqued; whether the spindle nut is not properly torqued; whether at least one spindle nut of the set of spindle nuts is not properly torqued; whether the bearing is not properly lubricated; whether the bearing is worn; whether the set of bearings is not properly lubricated; whether the set of bearings is worn; whether the brake pad is worn; whether the brake pad is damaged; whether the brake drum is worn; whether the brake drum is damaged; whether the brake rotor is worn; whether the brake rotor is damaged; whether the brake caliper is worn; whether the brake caliper is damaged; whether the tire is not properly inflated; whether the tire is damaged; whether at least one tire of the set of tires is not properly inflated; or whether at least one tire of the set of tires is damaged.
37. The method of any one of clauses 17 to 34, wherein the predicted state is an approximate load on the second vehicle component.
38. The method of any one of clauses 17 to 37, further comprising: providing a second frequency domain representation of the sample of vibration data to a second trained machine learning model that is trained to predict a state of a third vehicle component based on vibrations of the first vehicle component.
39. The method of clause 38, wherein each of the second vehicle component and the third vehicle component comprises a different one of the following vehicle components: a lug nut; a set of lug nuts; a lug bolt; a set of lug bolts; a spindle nut; a set of spindle nuts; a bearing of a hub assembly; a set of bearings of a hub assembly; a brake pad; a brake drum; a brake rotor; a brake caliper; a tire; or a set of tires.
40. The method of any one of clauses 17 to 39, wherein the vibration sensor is mounted to the first vehicle component, and wherein the second vehicle component is coupled to the first vehicle component, such that vibrations of the second vehicle component are transmitted to the vibration sensor via the first vehicle component.
41. A non-transitory computer-readable medium storing computer-executable code, comprising code for causing a computer to cause a processor to: perform a method of any of one of clauses 17 to 41.

In some embodiments, any suitable computer readable media can be used for storing instructions for performing functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that above-described steps of the process of FIGS. 5 and 6 can be executed or performed in any suitable order or sequence not limited to the order and sequence shown and described in the figures. Also, some of the above steps of the process of FIGS. 5 and 6 can be executed or performed substantially simultaneously where appropriate or in parallel to reduce latency and processing times.

This written description uses examples to disclose the invention(s), including the best mode, and also to enable any person skilled in the art to make and use the invention(s). Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention(s) is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A system for monitoring a state of a rotating vehicle component, the system comprising:
a vibration sensor configured to be mounted to a first vehicle component which is coupled to a second vehicle component; and
one or more hardware processors configured to:
provide a frequency domain representation of a sample of vibration data recorded using the vibration sensor to a trained machine learning model that is trained to predict a state of the second vehicle component based on vibrations of the first vehicle component;
receive, from the trained machine learning model, an output indicative of a predicted state of the second vehicle component at the time that the sample of vibration data was recorded; and
transmit a signal to an external device that is indicative of a current predicted state of the second vehicle component.

2. The system of claim 1, wherein the one or more hardware processors are further configured to:
receive, from a vibration data source, the sample of vibration data;
normalize the sample of vibration data; and
convert the sample of vibration data to the frequency domain representation.

3. The system of claim 2, wherein the vibration data source comprises the vibration sensor.

4. The system of claim 1, wherein the frequency domain representation comprises a spectrogram.

5. The system of claim 1, wherein the vibration sensor comprises a piezoelectric microphone.

6. The system of claim 1, wherein the trained machine learning model is a classification model that is trained to predict a likelihood that the second vehicle component coupled to the first vehicle component from which the vibration data was recorded is an example of each of a plurality of classes.

7. The system of claim 6, wherein the first vehicle component and the second vehicle component are rotatably coupled portions of an axle assembly of a vehicle, and
wherein the trained machine learning model is trained to predict whether the first vehicle component and second vehicle component are securely coupled.

8. The system of claim 7, wherein the first vehicle component is a non-rotating portion of a beam axle of the axle assembly, the second vehicle component is a rotating portion of a hub assembly of the axle assembly, and the plurality of classes includes a properly torqued spindle nut class indicative of whether a spindle nut used to secure the hub assembly to the non-rotating portion of the beam axle is properly torqued, indicating that the first vehicle component and second vehicle component are securely coupled.

9. The system of claim 1, wherein the one or more hardware processors are further configured to:
receive, from the trained machine learning model, a plurality of outputs indicative of a predicted state of the second vehicle component at different times; and
determine a final prediction based on the plurality of outputs;
determine that a user is to be presented with an alert based on the final prediction; and
transmit the signal to the external device, thereby causing an alert to be presented to the user by the external device.

10. The system of claim 1, wherein the external device is a mobile computing device associated with a user.

11. The system of claim 1, wherein the first vehicle component and the second vehicle component are portions of an axle assembly of a trailer that is configured to be coupled to a tractor via a fifth wheel.

12. The system of claim 11, wherein the external device is an embedded computing device of the tractor.

13. The system of claim 1, wherein the one or more hardware processors are further configured to:
receive, from the vibration sensor, a stream of audio data;
record a portion of the stream of audio data as an audio file;
divide the audio file into a plurality of vibration data samples, including the sample of vibration data;
normalize each of the plurality of the vibration data samples based on audio levels within the respective sample;
convert the plurality of vibration data samples into a plurality of mel spectrograms;
provide the plurality of mel spectrograms to the trained machine learning model as a batch;
receive a plurality of outputs, each corresponding to a respective vibration data sample of the plurality of vibration data samples, and each indicative of the predicted state of the second vehicle component at the time that the respective vibration data sample was recorded; and
determine a final prediction based on the plurality of outputs.

14. The system of claim 1, wherein the trained machine learning model is a regression model that is trained to predict a current state of the second vehicle component coupled to the first vehicle component from which the vibration data was recorded from a range of states.

15. The system of claim 1, wherein the predicted state is an approximate load on the second vehicle component.

16. The system of claim 1, wherein the one or more hardware processors are further configured to:
provide a second frequency domain representation of the sample of vibration data to a second trained machine learning model that is trained to predict a state of a third vehicle component based on vibrations of the first vehicle component.

17. The system of claim 1, further comprising:
the first vehicle component,
wherein the vibration sensor is mounted to the first vehicle component; and
the second vehicle component,
wherein the second vehicle component is coupled to the first vehicle component, such that vibrations of the second vehicle component are transmitted to the vibration sensor via the first vehicle component.

18. A method for monitoring a state of a rotating vehicle component, the method comprising:
providing a frequency domain representation of a sample of vibration data recorded using a vibration sensor mounted to a first vehicle component which is coupled to a second vehicle component to a trained machine learning model that is trained to predict a state of the second vehicle component based on vibrations of the first vehicle component;
receiving, from the trained machine learning model, an output indicative of a predicted state of the second vehicle component at the time that the sample of vibration data was recorded; and
transmitting a signal to an external device that is indicative of a current predicted state of the second vehicle component.

19. The method of claim 18, further comprising:
receiving, from a vibration data source, the sample of vibration data;
normalizing the sample of vibration data; and
converting the sample of vibration data to the frequency domain representation.

20. The method of claim 19, wherein the vibration data source comprises the vibration sensor.
